(19) United States
(12) Patent Application Publication
(10) Pub. No.: US 2025/0175958 A1
(43) Pub. Date: May 29, 2025

(54) REDUCED COMPLEXITY CAPABILITY FOR UPLINK TRANSMIT SWITCHING

(71) Applicant: QUALCOMM Incorporated, San Diego, CA (US)

(72) Inventors: Yiqing CAO, Beijing (CN); Yi HUANG, San Diego, CA (US); Peter GAAL, San Diego, CA (US); Enoch Shiao-Kuang LU, San Diego, CA (US); Rebecca Wen-Ling YUAN, San Diego, CA (US); Sanghoon KIM, San Jose, CA (US)

(21) Appl. No.: 18/841,252

(22) PCT Filed: Apr. 29, 2022
(86) PCT No.: PCT/CN2022/090173

§ 371 Date: Aug. 23, 2024

(51) Int. Cl. H04W 72/0453; H04W 36/00; H04W 72/231

(52) U.S. Cl. CPC H04W 72/0453; H04W 36/00692; H04W 72/231

(57) ABSTRACT

Aspects of the present disclosure allow for uplink (UL) transmit (Tx) switching across multiple bands. In an aspect, in order to reduce switching complexity, a UE may report its switching capability on one or more switching band pairs, and may use a bridge band for switching out of the reported band pairs. In some alternative aspects, the UE may define an anchor band which is always on. In these aspects, one or more other bands may be activated by the network. In some aspects, the network may configure a switching gap in a band based on priorities defined across multiple bands. In an alternative aspect, the network may dynamically configure a switching band pair and also configure which band in the configured band pair includes the switching gap.

### BACKGROUND

The present disclosure relates generally to wireless communication systems, and more particularly, to techniques for transmit switching in wireless communication.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

An example aspect includes a method of wireless communication by a user equipment (UE), comprising identifying, by the UE, control information indicated by a base station for transmitting an uplink message, wherein the control information indicates switching from a first frequency band to a second frequency band. The method further includes switching, by the UE, from the first frequency band to the second frequency band responsive to both the first frequency band and the second frequency band being in a same band pair among a plurality of band pairs that are configurable for uplink transmission, wherein the plurality of band pairs have a bridge band in common. Additionally, the method further includes switching, by the UE, from the first frequency band to the bridge band and then from the bridge band to the second frequency band responsive to the first frequency band and the second frequency band being in two different band pairs among the plurality of band pairs. Additionally, the method further includes transmitting the uplink message on the second frequency band.

Another example aspect includes a user equipment (UE) apparatus, comprising a memory and a processor coupled with the memory. The processor is configured to identify control information indicated by a base station for transmitting an uplink message, wherein the control information indicates switching from a first frequency band to a second frequency band. The processor is further configured to switch from the first frequency band to the second frequency band responsive to both the first frequency band and the second frequency band being in a same band pair among a plurality of band pairs that are configurable for uplink transmission, wherein the plurality of band pairs have a bridge band in common. Additionally, the processor further configured to switch from the first frequency band to the bridge band and then from the bridge band to the second frequency band responsive to the first frequency band and the second frequency band being in two different band pairs among the plurality of band pairs. Additionally, the processor further configured to transmit the uplink message on the second frequency band.

Another example aspect includes a user equipment (UE) apparatus, comprising means for identifying control information indicated by a base station for transmitting an uplink message, wherein the control information indicates switching from a first frequency band to a second frequency band. The apparatus further includes means for switching from the first frequency band to the second frequency band responsive to both the first frequency band and the second frequency band being in a same band pair among a plurality of band pairs that are configurable for uplink transmission, wherein the plurality of band pairs have a bridge band in common. Additionally, the apparatus further includes means for switching from the first frequency band to the bridge band and then from the bridge band to the second frequency band responsive to the first frequency band and the second frequency band being in two different band pairs among the plurality of band pairs. Additionally, the apparatus further includes means for transmitting the uplink message on the second frequency band.

Another example aspect includes a computer-readable medium comprising stored instructions for wireless communication by a user equipment (UE), wherein the instructions are executable by a processor to identify control information indicated by a base station for transmitting an uplink message, wherein the control information indicates switching from a first frequency band to a second frequency band. The instructions are further executable to switch from the first frequency band to the second frequency band responsive to both the first frequency band and the second frequency band being in a same band pair among a plurality of band pairs that are configurable for uplink transmission, wherein the plurality of band pairs have a bridge band in common. Additionally, the instructions are further executable to switch from the first frequency band to the bridge band and then from the bridge band to the second frequency band responsive to the first frequency band and the second frequency band being in two different band pairs among the plurality of band pairs. Additionally, the instructions are further executable to transmit the uplink message on the second frequency band.

An example aspect includes a method of wireless communication by a user equipment (UE), comprising determining, by the UE, control information indicated by a base station for transmitting an uplink message, wherein the control information requires switching from a first frequency band to a second frequency band. The method further includes switching, by the UE, from the first frequency band to the second frequency band responsive to one of the first frequency band and the second frequency band being an anchor band configured for the UE.

Another example aspect includes a user equipment (UE) apparatus, comprising a memory and a processor coupled with the memory. The processor is configured to determine control information indicated by a base station for transmitting an uplink message, wherein the control information requires switching from a first frequency band to a second frequency band. The processor is further configured to switch from the first frequency band to the second frequency band responsive to one of the first frequency band and the second frequency band being an anchor band configured for the UE.

Another example aspect includes a user equipment (UE) apparatus, comprising means for determining control information indicated by a base station for transmitting an uplink message, wherein the control information requires switching from a first frequency band to a second frequency band. The apparatus further includes means for switching from the first frequency band to the second frequency band responsive to one of the first frequency band and the second frequency band being an anchor band configured for the UE.

Another example aspect includes a computer-readable medium comprising stored instructions for wireless communication by a user equipment (UE), wherein the instructions are executable by a processor to determine control information indicated by a base station for transmitting an uplink message, wherein the control information requires switching from a first frequency band to a second frequency band. The instructions are further executable to switch from the first frequency band to the second frequency band responsive to one of the first frequency band and the second frequency band being an anchor band configured for the UE.

An example aspect includes a method of wireless communication by a user equipment (UE), comprising selecting, by the UE, a frequency band for placing an uplink transmit switching gap thereon, wherein the frequency band is selected from two or more bands that are configured by a base station for uplink transmit switching, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band. The method further includes transmitting, by the UE to the base station, an uplink message using uplink transmit switching on the two or more bands, including placing the uplink transmit switching gap over the frequency band.

Another example aspect includes a user equipment (UE) apparatus, comprising a memory and a processor coupled with the memory. The processor is configured to select a frequency band for placing an uplink transmit switching gap thereon, wherein the frequency band is selected from two or more bands that are configured by a base station for uplink transmit switching, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band. The processor is further configured to transmit, by the UE to the base station, an uplink message using uplink transmit switching on the two or more bands, including placing the uplink transmit switching gap over the frequency band.

Another example aspect includes a user equipment (UE) apparatus, comprising means for selecting a frequency band for placing an uplink transmit switching gap thereon, wherein the frequency band is selected from two or more bands that are configured by a base station for uplink transmit switching, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band. The apparatus further includes means for transmitting, by the UE to the base station, an uplink message using uplink transmit switching on the two or more bands, including placing the uplink transmit switching gap over the frequency band.

Another example aspect includes a computer-readable medium comprising stored instructions for wireless communication by a user equipment (UE), wherein the instructions are executable by a processor to select a frequency band for placing an uplink transmit switching gap thereon, wherein the frequency band is selected from two or more bands that are configured by a base station for uplink transmit switching, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band. The instructions are further executable to transmit, by the UE to the base station, an uplink message using uplink transmit switching on the two or more bands, including placing the uplink transmit switching gap over the frequency band.

An example aspect includes a method of wireless communication by a user equipment (UE), comprising receiving, by the UE from a base station, a configuration message that indicates to place an uplink transmit switching gap on a frequency band within two or more bands that are configured by the base station for uplink transmit switching of the UE. The method further includes transmitting, by the UE to the base station, an uplink message using uplink transmit switching on the two or more bands that are configured by the base station for uplink transmit switching, including placing the uplink transmit switching gap over the frequency band indicated in the configuration message by the base station.

Another example aspect includes a user equipment (UE) apparatus, comprising a memory and a processor coupled with the memory. The processor is configured to receive, by the UE from a base station, a configuration message that indicates to place an uplink transmit switching gap on a frequency band within two or more bands that are configured by the base station for uplink transmit switching of the UE. The processor is further configured to transmit, by the UE to the base station, an uplink message using uplink transmit switching on the two or more bands that are configured by the base station for uplink transmit switching, including placing the uplink transmit switching gap over the frequency band indicated in the configuration message by the base station.

Another example aspect includes a user equipment (UE) apparatus, comprising means for receiving, by the UE from a base station, a configuration message that indicates to place an uplink transmit switching gap on a frequency band within two or more bands that are configured by the base station for uplink transmit switching of the UE. The apparatus further includes means for transmitting, by the UE to the base station, an uplink message using uplink transmit switching on the two or more bands that are configured by the base station for uplink transmit switching, including placing the uplink transmit switching gap over the frequency band indicated in the configuration message by the base station.

Another example aspect includes a computer-readable medium comprising stored instructions for wireless communication by a user equipment (UE), wherein the instructions are executable by a processor to receive, by the UE from a base station, a configuration message that indicates to place an uplink transmit switching gap on a frequency band within two or more bands that are configured by the base station for uplink transmit switching of the UE. The instructions are further executable to transmit, by the UE to the base station, an uplink message using uplink transmit switching on the two or more bands that are configured by the base station for uplink transmit switching, including placing the uplink transmit switching gap over the frequency band indicated in the configuration message by the base station.

An example aspect includes a method of wireless communication by a base station, comprising transmitting control information to a user equipment (UE), wherein the control information indicates switching from a first frequency band to a second frequency band for transmitting an uplink message. In this case, the control information causes the UE to switch from the first frequency band to the second frequency band responsive to both the first frequency band and the second frequency band being in a same band pair among a plurality of band pairs that are configurable for uplink transmission, wherein the plurality of band pairs have a bridge band in common; and the control information causes the UE to switch from the first frequency band to the bridge band and then from the bridge band to the second frequency band responsive to the first frequency band and the second frequency band being in two different band pairs among the plurality of band pairs. The method further includes receiving the uplink message on the second frequency band.

Another example aspect includes an apparatus for wireless communication by a base station, comprising a memory and a processor coupled with the memory. The processor is configured to transmit control information to a user equipment (UE), wherein the control information indicates switching from a first frequency band to a second frequency band for transmitting an uplink message. In this case, the control information causes the UE to switch from the first frequency band to the second frequency band responsive to both the first frequency band and the second frequency band being in a same band pair among a plurality of band pairs that are configurable for uplink transmission, wherein the plurality of band pairs have a bridge band in common; and the control information causes the UE to switch from the first frequency band to the bridge band and then from the bridge band to the second frequency band responsive to the first frequency band and the second frequency band being in two different band pairs among the plurality of band pairs. The processor is further configured to receive the uplink message on the second frequency band.

Another example aspect includes an apparatus for wireless communication by a base station, comprising means for transmitting control information to a user equipment (UE), wherein the control information indicates switching from a first frequency band to a second frequency band for transmitting an uplink message. In this case, the control information causes the UE to switch from the first frequency band to the second frequency band responsive to both the first frequency band and the second frequency band being in a same band pair among a plurality of band pairs that are configurable for uplink transmission, wherein the plurality of band pairs have a bridge band in common; and the control information causes the UE to switch from the first frequency band to the bridge band and then from the bridge band to the second frequency band responsive to the first frequency band and the second frequency band being in two different band pairs among the plurality of band pairs. The apparatus further includes means for receiving the uplink message on the second frequency band.

Another example aspect includes a computer-readable medium comprising stored instructions for wireless communication by a base station, wherein the instructions are executable by a processor to transmit control information to a user equipment (UE), wherein the control information indicates switching from a first frequency band to a second frequency band for transmitting an uplink message. In this case, the control information causes the UE to switch from the first frequency band to the second frequency band responsive to both the first frequency band and the second frequency band being in a same band pair among a plurality of band pairs that are configurable for uplink transmission, wherein the plurality of band pairs have a bridge band in common; and the control information causes the UE to switch from the first frequency band to the bridge band and then from the bridge band to the second frequency band responsive to the first frequency band and the second frequency band being in two different band pairs among the plurality of band pairs. The instructions are further executable to receive the uplink message on the second frequency band.

An example aspect includes a method of wireless communication by a base station, comprising transmitting control information to a user equipment (UE), wherein the control information indicates switching from a first frequency band to a second frequency band for transmitting an uplink message, and wherein the control information causes the UE to switch from the first frequency band to the second frequency band responsive to one of the first frequency band and the second frequency band being an anchor band configured for the UE.

Another example aspect includes an apparatus for wireless communication by a base station, comprising a memory and a processor coupled with the memory. The processor is configured to transmit control information to a user equipment (UE), wherein the control information indicates switching from a first frequency band to a second frequency band for transmitting an uplink message, and wherein the control information causes the UE to switch from the first frequency band to the second frequency band responsive to one of the first frequency band and the second frequency band being an anchor band configured for the UE.

Another example aspect includes an apparatus for wireless communication by a base station, comprising means for transmitting control information to a user equipment (UE), wherein the control information indicates switching from a first frequency band to a second frequency band for transmitting an uplink message, and wherein the control information causes the UE to switch from the first frequency band to the second frequency band responsive to one of the first frequency band and the second frequency band being an anchor band configured for the UE.

Another example aspect includes a computer-readable medium comprising stored instructions for wireless communication by a base station, wherein the instructions are executable by a processor to transmit control information to a user equipment (UE), wherein the control information indicates switching from a first frequency band to a second frequency band for transmitting an uplink message, and wherein the control information causes the UE to switch from the first frequency band to the second frequency band responsive to one of the first frequency band and the second frequency band being an anchor band configured for the UE.

An example aspect includes a method of wireless communication by a base station, comprising configuring a user equipment (UE) for uplink transmit switching on two or more bands, wherein the configuring causes the UE to select a frequency band for placing an uplink transmit switching gap thereon, wherein the frequency band is selected from the two or more bands, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band. The method further includes receiving an uplink message using uplink transmit switching on the two or more bands, wherein the uplink transmit switching places the uplink transmit switching gap over the frequency band.

Another example aspect includes an apparatus for wireless communication by a base station, comprising a memory and a processor coupled with the memory. The processor is configured to configure a user equipment (UE) for uplink transmit switching on two or more bands, wherein to configure the UE causes the UE to select a frequency band for placing an uplink transmit switching gap thereon, wherein the frequency band is selected from the two or more bands, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band. The processor is further configured to receive an uplink message using uplink transmit switching on the two or more bands, wherein the uplink transmit switching places the uplink transmit switching gap over the frequency band.

Another example aspect includes an apparatus for wireless communication by a base station, comprising means for configuring a user equipment (UE) for uplink transmit switching on two or more bands, wherein the means for configuring causes the UE to select a frequency band for placing an uplink transmit switching gap thereon, wherein the frequency band is selected from the two or more bands, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band. The apparatus further includes means for receiving an uplink message using uplink transmit switching on the two or more bands, wherein the uplink transmit switching places the uplink transmit switching gap over the frequency band.

Another example aspect includes a computer-readable medium comprising stored instructions for wireless communication by a base station, wherein the instructions are executable by a processor to configure a user equipment (UE) for uplink transmit switching on two or more bands, wherein to configure the UE causes the UE to select a frequency band for placing an uplink transmit switching gap thereon, wherein the frequency band is selected from the two or more bands, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band. The instructions are further executable to receive an uplink message using uplink transmit switching on the two or more bands, wherein the uplink transmit switching places the uplink transmit switching gap over the frequency band.

An example aspect includes a method of wireless communication by a base station, comprising transmitting, to a user equipment (UE), a configuration message that indicates to place an uplink transmit switching gap on a frequency band within two or more bands that are configured by the base station for uplink transmit switching of the UE. The method further includes receiving an uplink message using uplink transmit switching on the two or more bands that are configured by the base station for uplink transmit switching, wherein the uplink transmit switching places the uplink transmit switching gap over the frequency band.

Another example aspect includes an apparatus for wireless communication by a base station, comprising a memory and a processor coupled with the memory. The processor is configured to transmit, to a user equipment (UE), a configuration message that indicates to place an uplink transmit switching gap on a frequency band within two or more bands that are configured by the base station for uplink transmit switching of the UE. The processor is further configured to receive an uplink message using uplink transmit switching on the two or more bands that are configured by the base station for uplink transmit switching, wherein the uplink transmit switching places the uplink transmit switching gap over the frequency band.

Another example aspect includes an apparatus for wireless communication by a base station, comprising means for transmitting, to a user equipment (UE), a configuration message that indicates to place an uplink transmit switching gap on a frequency band within two or more bands that are configured by the base station for uplink transmit switching of the UE. The apparatus further includes means for receiving an uplink message using uplink transmit switching on the two or more bands that are configured by the base station for uplink transmit switching, wherein the uplink transmit switching places the uplink transmit switching gap over the frequency band.

Another example aspect includes a computer-readable medium comprising stored instructions for wireless communication by a base station, wherein the instructions are executable by a processor to transmit, to a user equipment (UE), a configuration message that indicates to place an uplink transmit switching gap on a frequency band within two or more bands that are configured by the base station for uplink transmit switching of the UE. The instructions are further executable to receive an uplink message using uplink transmit switching on the two or more bands that are configured by the base station for uplink transmit switching, wherein the uplink transmit switching places the uplink transmit switching gap over the frequency band.

Some further aspects are described below.

1. A method of wireless communication by a user equipment (UE), comprising:
identifying, by the UE, control information indicated by a base station for transmitting an uplink message, wherein the control information indicates switching from a first frequency band to a second frequency band;
switching, by the UE, from the first frequency band to the second frequency band responsive to both the first frequency band and the second frequency band being in a same band pair among a plurality of band pairs that are configurable for uplink transmission, wherein the plurality of band pairs have a bridge band in common;
switching, by the UE, from the first frequency band to the bridge band and then from the bridge band to the second frequency band responsive to the first frequency band and the second frequency band being in two different band pairs among the plurality of band pairs; and
transmitting the uplink message on the second frequency band.
   2. The method of clause 1, wherein the UE is configured by the base station for uplink carrier aggregation (CA) on at least one of the first frequency band or the second frequency band.
   3. The method of clause 1 or 2, wherein the UE is configured by the base station for dual uplink transmission on at least one of the first frequency band or the second frequency band.
   4. The method of any one of clauses 1 to 3, wherein at least one of the first frequency band or the second frequency band is configured by the base station as a supplemental uplink (SUL) band.
   5. The method of any one of clauses 1 to 4, wherein the control information is included in DCI or RRC signaling.
   6. The method of any one of clauses 1 to 5, wherein the plurality of band pairs are indicated by the UE to the base station via a switching capability report.
   7. A method of wireless communication by a user equipment (UE), comprising:
determining, by the UE, control information indicated by a base station for transmitting an uplink message, wherein the control information requires switching from a first frequency band to a second frequency band; and
switching, by the UE, from the first frequency band to the second frequency band responsive to one of the first frequency band and the second frequency band being an anchor band configured for the UE.
   8. The method of clause 7, wherein the anchor band is always activated.
   9. The method of clause 7 or 8, wherein a plurality of frequency bands other than the anchor band are always activated.
   10. The method of any one of clauses 7 to 9, further comprising switching from the first frequency band to the second frequency band and ceasing simultaneous transmission on more than one band, responsive to neither one of the first frequency band or the second frequency band being the anchor band, wherein the second frequency band supports a single layer transmission.
   11. The method of any one of clauses 7 to 10, wherein the anchor band is configured by the base station via RRC signaling or activated by the base station via MAC-CE signaling.
   12. The method of any one of clauses 7 to 11, wherein at least one of the first frequency band or the second frequency band is configured by the base station via RRC signaling or activated by the base station via MAC-CE signaling.
   13. The method of any one of clauses 7 to 12, wherein the anchor band is indicated by the UE to the base station as a capability of the UE.
   14. The method of any one of clauses 7 to 13, wherein the anchor band is selected and configured by the base station responsive to the anchor band not being indicated by the UE as a capability of the UE.
   15. The method of any one of clauses 7 to 14, wherein the control information is included in a DCI, MAC-CE, or RRC signaling.
   16. The method of any one of clauses 7 to 15, wherein the switching is according to switched uplink with no simultaneous transmission or dual uplink with simultaneous transmission, as indicated by a UE-reported switching option capability.
   17. The method of any one of clauses 7 to 16, wherein a plurality of bands including at least one of the first frequency band or the second frequency band are indicated by the UE to the base station via a switching capability report.
   18. The method of any one of clauses 7 to 17, wherein an uplink transmit switching gap is placed on the anchor band.
   19. A method of wireless communication by a user equipment (UE), comprising:
selecting, by the UE, a frequency band for placing an uplink transmit switching gap thereon, wherein the frequency band is selected from two or more bands that are configured by a base station for uplink transmit switching, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band; and
transmitting, by the UE to the base station, an uplink message using uplink transmit switching on the two or more bands, including placing the uplink transmit switching gap over the frequency band.
   20. The method of clause 19, wherein, within the two or more bands that are configured by the base station for uplink transmit switching, only the frequency band is included in the subset.
   21. The method of clause 19 or 20, wherein responsive to more than one band of the two or more bands being in the subset, the uplink transmit switching gap is placed over the frequency band which has a highest or lowest priority among the more than one band.
   22. A method of wireless communication by a user equipment (UE), comprising:
receiving, by the UE from a base station, a configuration message that indicates to place an uplink transmit switching gap on a frequency band within two or more bands that are configured by the base station for uplink transmit switching of the UE; and
transmitting, by the UE to the base station, an uplink message using uplink transmit switching on the two or more bands that are configured by the base station for uplink transmit switching, including placing the uplink transmit switching gap over the frequency band indicated in the configuration message by the base station.
   23. The method of clause 22, wherein configuring the two or more bands for uplink transmit switching and configuring the frequency band for placing the uplink transmit switching gap thereon are performed together in a same time scale.
   24. The method of clause 22 or 23, wherein configuring the two or more bands for uplink transmit switching and configuring the frequency band for placing the uplink transmit switching gap thereon are performed together in RRC signaling.
   25. The method of any one of clauses 22 to 24, wherein configuring the two or more bands for uplink transmit switching and configuring the frequency band for placing the uplink transmit switching gap thereon are performed together in MAC-CE signaling.
   26. A method of wireless communication by a base station, comprising:
transmitting control information to a user equipment (UE), wherein the control information indicates switching from a first frequency band to a second frequency band for transmitting an uplink message;
wherein the control information causes the UE to switch from the first frequency band to the second frequency band responsive to both the first frequency band and the second frequency band being in a same band pair among a plurality of band pairs that are configurable for uplink transmission, wherein the plurality of band pairs have a bridge band in common;
wherein the control information causes the UE to switch from the first frequency band to the bridge band and then from the bridge band to the second frequency band responsive to the first frequency band and the second frequency band being in two different band pairs among the plurality of band pairs; and
receiving the uplink message on the second frequency band.
   27. The method of clause 26, wherein the UE is configured by the base station for uplink carrier aggregation (CA) on at least one of the first frequency band or the second frequency band.
   28. The method of clause 26 or 27, wherein the UE is configured by the base station for dual uplink transmission on at least one of the first frequency band or the second frequency band.
   29. The method of any one of clauses 26 to 28, wherein at least one of the first frequency band or the second frequency band is configured by the base station as a supplemental uplink (SUL) band.
   30. The method of any one of clauses 26 to 29, wherein the control information is included in DCI or RRC signaling.
   31. The method of any one of clauses 26 to 30, wherein the plurality of band pairs are indicated by the UE to the base station via a switching capability report.
   32. A method of wireless communication by a base station, comprising:
transmitting control information to a user equipment (UE), wherein the control information indicates switching from a first frequency band to a second frequency band for transmitting an uplink message; and
wherein the control information causes the UE to switch from the first frequency band to the second frequency band responsive to one of the first frequency band and the second frequency band being an anchor band configured for the UE.
   33. The method of clause 32, wherein the anchor band is always activated.
   34. The method of clause 32 or 33, wherein a plurality of frequency bands other than the anchor band are always activated.
   35. The method of any one of clauses 32 to 34, further comprising switching from the first frequency band to the second frequency band and ceasing simultaneous transmission on more than one band, responsive to neither one of the first frequency band or the second frequency band being the anchor band, wherein the second frequency band supports a single layer transmission.
   36. The method of any one of clauses 32 to 35, wherein the anchor band is configured by the base station via RRC signaling or activated by the base station via MAC-CE signaling.
   37. The method of any one of clauses 32 to 36, wherein at least one of the first frequency band or the second frequency band is configured by the base station via RRC signaling or activated by the base station via MAC-CE signaling.
   38. The method of any one of clauses 32 to 37, wherein the anchor band is indicated by the UE to the base station as a capability of the UE.
   39. The method of any one of clauses 32 to 38, wherein the anchor band is selected and configured by the base station responsive to the anchor band not being indicated by the UE as a capability of the UE.
   40. The method of any one of clauses 32 to 39, wherein the control information is included in a DCI, MAC-CE, or RRC signaling.
   41. The method of any one of clauses 32 to 40, wherein the switching is according to switched uplink with no simultaneous transmission or dual uplink with simultaneous transmission, as indicated by a UE-reported switching option capability.
   42. The method of any one of clauses 32 to 41, wherein a plurality of bands including at least one of the first frequency band or the second frequency band are indicated by the UE to the base station via a switching capability report.
   43. The method of any one of clauses 32 to 42, wherein an uplink transmit switching gap is placed on the anchor band.
   44. A method of wireless communication by a base station, comprising:
configuring a user equipment (UE) for uplink transmit switching on two or more bands;
wherein the configuring causes the UE to select a frequency band for placing an uplink transmit switching gap thereon, wherein the frequency band is selected from the two or more bands, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band; and
receiving an uplink message using uplink transmit switching on the two or more bands, wherein the uplink transmit switching places the uplink transmit switching gap over the frequency band.
   45. The method of clause 44, wherein, within the two or more bands that are configured by the base station for uplink transmit switching, only the frequency band is included in the subset.
   46. The method of clause 44 or 45, wherein, responsive to more than one band of the two or more bands being in the subset, the uplink transmit switching gap is placed over the frequency band which has a highest or lowest priority among the more than one band.
   47. A method of wireless communication by a base station, comprising:
transmitting, to a user equipment (UE), a configuration message that indicates to place an uplink transmit switching gap on a frequency band within two or more bands that are configured by the base station for uplink transmit switching of the UE; and
receiving an uplink message using uplink transmit switching on the two or more bands that are configured by the base station for uplink transmit switching, wherein the uplink transmit switching places the uplink transmit switching gap over the frequency band.
   48. The method of clause 47, wherein configuring the two or more bands for uplink transmit switching and configuring the frequency band for placing the uplink transmit switching gap thereon are performed together in a same time scale.
   49. The method of clause 47 or 48, wherein configuring the two or more bands for uplink transmit switching and configuring the frequency band for placing the uplink transmit switching gap thereon are performed together in RRC signaling.
   50. The method of any one of clauses 47 to 49, wherein configuring the two or more bands for uplink transmit switching and configuring the frequency band for placing the uplink transmit switching gap thereon are performed together in MAC-CE signaling.
   51. A user equipment (UE) for wireless communication, comprising:
a memory; and
at least one processor coupled to the memory and configured to perform the method of any one of clauses 1 to 25.
   52. A base station for wireless communication, comprising:
a memory; and
at least one processor coupled to the memory and configured to perform the method of any one of clauses 26 to 50.
   53. An apparatus comprising means for performing the method of any one of clauses 1 to 50.
   54. A computer-readable medium storing computer executable code, the code when executed by a processor causes the processor to perform the method of any one of clauses 1 to 50.
   55. The computer-readable medium of clause 54, wherein the computer-readable medium is a non-transitory computer-readable medium.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, including user equipment (UE) and base station components for uplink (UL) transmit (Tx) switching across multiple bands, according to some aspects of the present disclosure.

FIG. 2A is a diagram illustrating an example of a first 5G/NR frame for use in communication by the base stations and/or the UEs in FIG. 1, according to some aspects of the present disclosure.

FIG. 2B is a diagram illustrating an example of DL channels within a 5G/NR subframe for use in communication by the base stations and/or the UEs in FIG. 1, according to some aspects of the present disclosure.

FIG. 2C is a diagram illustrating an example of a second 5G/NR frame for use in communication by the base stations and/or the UEs in FIG. 1, according to some aspects of the present disclosure.

FIG. 2D is a diagram illustrating an example of UL channels within a 5G/NR subframe for use in communication by the base stations and/or the UEs in FIG. 1, according to some aspects of the present disclosure.

FIG. 3 is a diagram illustrating an example of UL Tx switching across three bands, according to some aspects of the present disclosure.

FIG. 4 is a diagram illustrating an example UE capability report indicating UE support for multiple bands for UL Tx switching, according to some aspects of the present disclosure.

FIG. 5 is a diagram illustrating an example UE capability report indicating UE support for one or more band combinations for UL Tx switching, according to some aspects of the present disclosure.

FIG. 6 is a diagram illustrating an example of dynamic UL Tx switching across three bands, according to some aspects of the present disclosure.

FIG. 7 is a diagram illustrating an example of a base station and a UE in an access network, according to some aspects of the present disclosure.

FIG. 8 is a diagram illustrating an example of disaggregated base station architecture, in accordance with various aspects of the present disclosure.

FIGS. 9, 11, 13, 15, 17, 19, 21, and 23 are block diagrams of example UE or network entity architectures, according to some aspects of the disclosure.

FIGS. 10, 12, 14, 16, 18, 20, 22, and 24 are flowcharts of example methods of wireless communications, according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts. Although the following description may be focused on 5G NR, the concepts described herein may be applicable to other similar areas, such as LTE, LTE-A, CDMA, GSM, and other wireless technologies.

Aspects of the present disclosure allow for uplink (UL) transmit (Tx) switching across multiple bands. In an aspect, in order to reduce switching complexity, a UE may report its switching capability on one or more switching band pairs, and may use a bridge band (or a transition band) for switching out of the reported band pairs. In an aspect, a bridge frequency band is a frequency band that is in each one of the reported band pairs and is used to switch from a first frequency band in one band pair to a second frequency band in another band pair. For example, a UE may switch from the first frequency band to the bridge frequency band and then from the bridge frequency band to the second frequency band. In some alternative aspects, the UE may define an anchor band which is always on. In these aspects, one or more other bands may be activated by the network. In some aspects, the network may configure a switching gap in a band based on priorities defined across multiple bands. In an alternative aspect, the network may dynamically configure a switching band pair and also configure which band in the configured band pair includes the switching gap.

Further details of the present aspects are described below with reference to the appended drawings.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

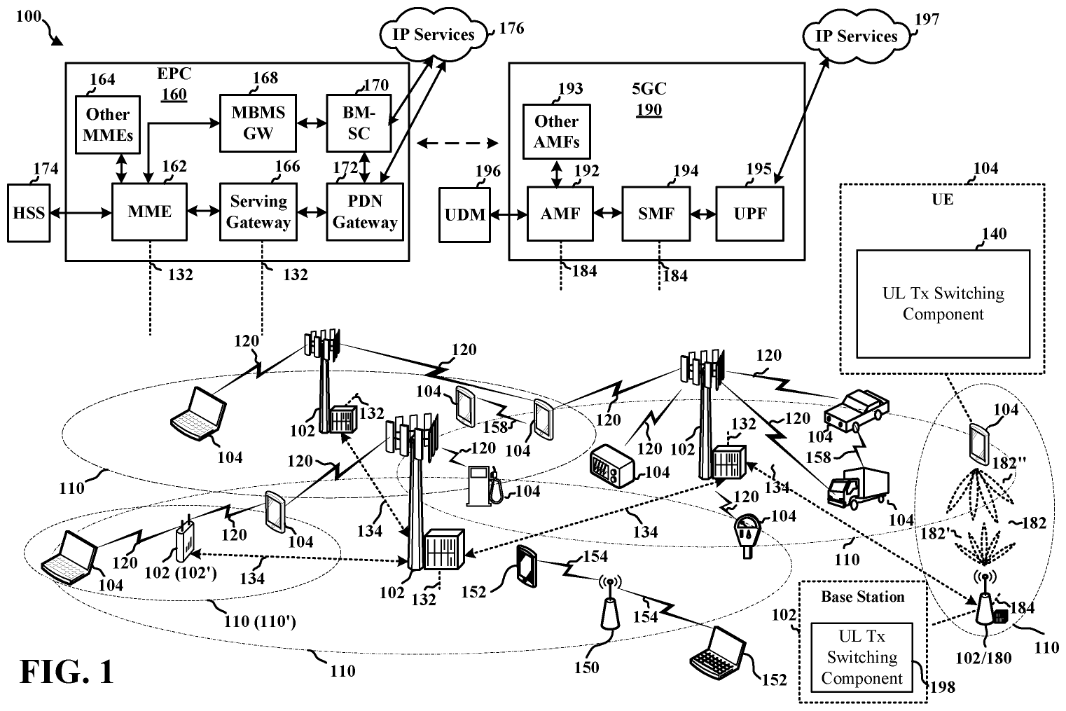

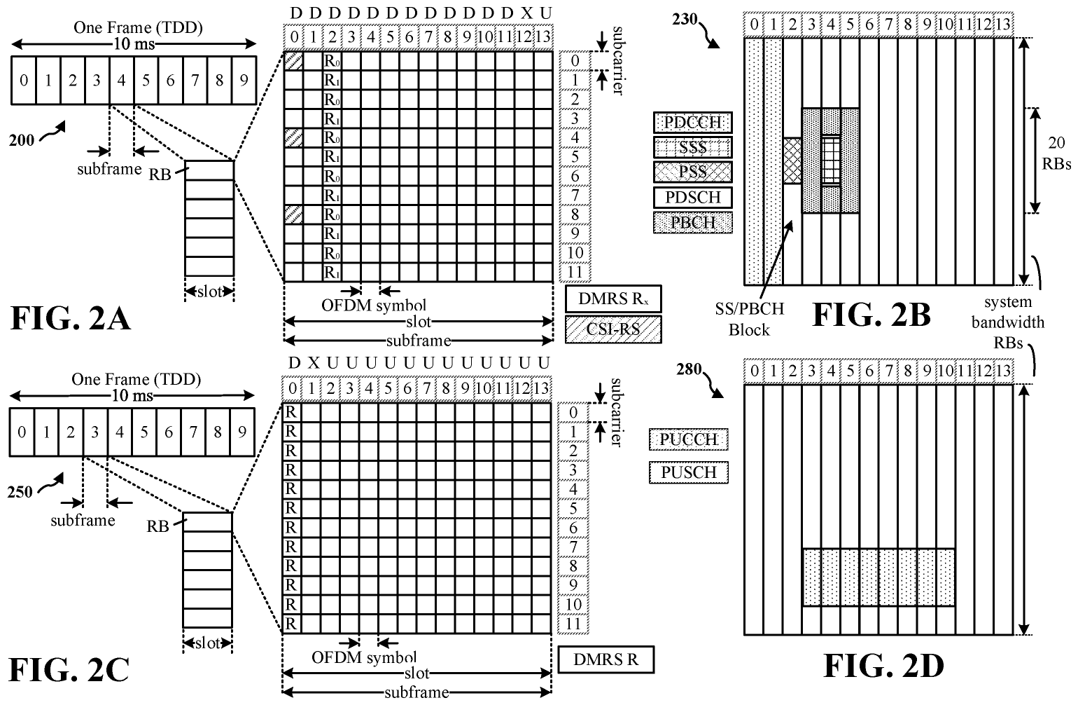

FIG. 1 is a diagram illustrating an example of a wireless communications system and an access network 100 including a UE 104 and a network entity 102, also referred to herein as a base station 102 (e.g., a gNB) and/or a disaggregated base station, configured to implement UL Tx switching across multiple bands. In an aspect, for example, the UE 104 includes an UL Tx switching component 140 configured to report the UL Tx switching capability of the UE 104 to the base station 102. In an aspect, for example, the UL Tx switching component 140 of the UE 104 may indicate the capability to switch over one or more band pairs, and a bridge band may be used for switching out of those band pairs. In some alternative aspects, the UL Tx switching component 140 of the UE 104 may indicate an anchor band which is always on. In some aspects, an UL Tx switching component 198 in the base station 102 may activate one or more bands for UL Tx switching of the UE 104. In some aspects, the UL Tx switching component 198 of the base station 102 may configure a gap in a band based on priorities defined across multiple bands. In an alternative aspect, the UL Tx switching component 198 of the base station 102 may dynamically configure a switching band pair for the UE and also configure which band in the configured band pair includes the switching gap. Further details of the operation of the UL Tx switching component 140 of the UE 104 and the UL Tx switching component 198 of the base station 102 are described below with reference to FIGS. 2A-2D and 3-9.

The wireless communications system (also referred to as a wireless wide area network (WWAN)) may also include other base stations 102, other UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., S1 interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 132, 134, 184 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158, e.g., including synchronization signals. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station 102 may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring to FIGS. 2A-2D, one or more example frame structures, channels, and resources may be used for communication between the base stations 102 and the UEs 104 of FIG. 1. FIG. 2A is a diagram 200 illustrating an example of a first subframe within a 5G/NR frame structure. FIG. 2B is a diagram 230 illustrating an example of DL channels within a 5G/NR subframe. FIG. 2C is a diagram 250 illustrating an example of a second subframe within a 5G/NR frame structure. FIG. 2D is a diagram 280 illustrating an example of UL channels within a 5G/NR subframe. The 5G/NR frame structure may be FDD in which for a particular set of subcarriers (carrier system bandwidth), subframes within the set of subcarriers are dedicated for either DL or UL, or may be TDD in which for a particular set of subcarriers (carrier system bandwidth), subframes within the set of subcarriers are dedicated for both DL and UL. In the examples provided by FIGS. 2A, 2C, the 5G/NR frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G/NR frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology p, there are 14 symbols/slot and 2 slots/subframe. The subcarrier spacing and symbol length/duration are a function of the numerology. The subcarrier spacing may be equal to 2^{μ}*15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 2A-2D provide an example of slot configuration 0 with 14 symbols per slot and numerology μ=0 with 1 slot per subframe. The subcarrier spacing is 15 kHz and symbol duration is approximately 66.7 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. Although not shown, the UE may transmit sounding reference signals (SRS). The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

In Release 18, uplink (UL) transmit (Tx) switching is performed using up to 4 bands. In Release 16 and Release 17, UL Tx switching is performed using 2 band, and when a UE is configured for inter-band carrier aggregation (CA) Option 1 (SwithedUL with no simultaneous transmission, as defined by 3GPP TS38.214) or supplemental uplink (SUL), the UE is not capable of UL Tx switching with simultaneous transmission from more than one band, but the UE is capable of doing so when configured for CA Option 2 (DualUL with the possibility of simultaneous transmission, as defined by 3GPP TS38.214).

Due to implementation restriction, inter-band UL CA (without UL Tx switching) is limited to 2 UL bands in some aspects of RAN4. Further, dynamic switching among 4 bands may be over-complicated, especially for a UE configured for CA Option 2 above.

In Release 16 and Release 17, the network configures a switching gap in one of the two switching bands via RRC signaling, and there is no uplink transmission in the switching gap. However, in Release 18, UL Tx switching may be performed for up to 4 bands, and the switching gap may not be on any of the bands in a configured switching band pair if the switching gap is still fixed in one band.

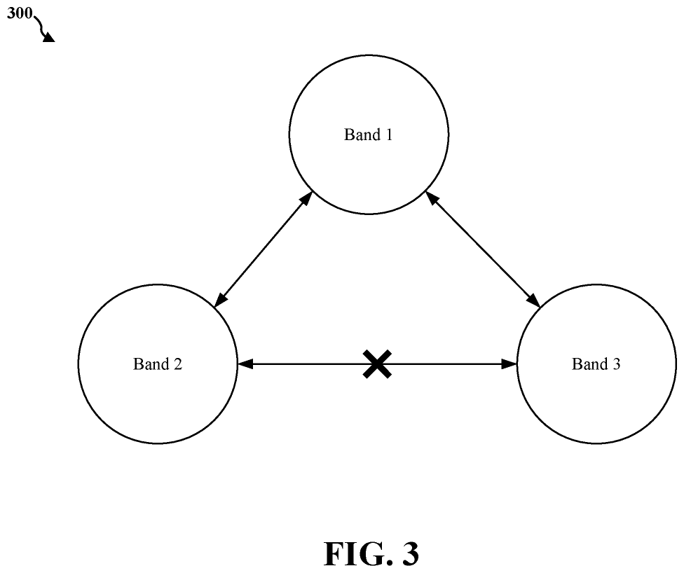

Accordingly, in some present aspects, in order to reduce the switching complexity, the UE report its switching capability on one or more switching band pairs. In these aspects, switching out of the band pairs is performed using a bridge frequency band. A bridge frequency band is a frequency band used to switch from a first frequency band to a second frequency band. For example, a UE may switch from a first frequency band to a bridge frequency band before switching to a second frequency band, as described, for example, with reference to FIG. 3 below.

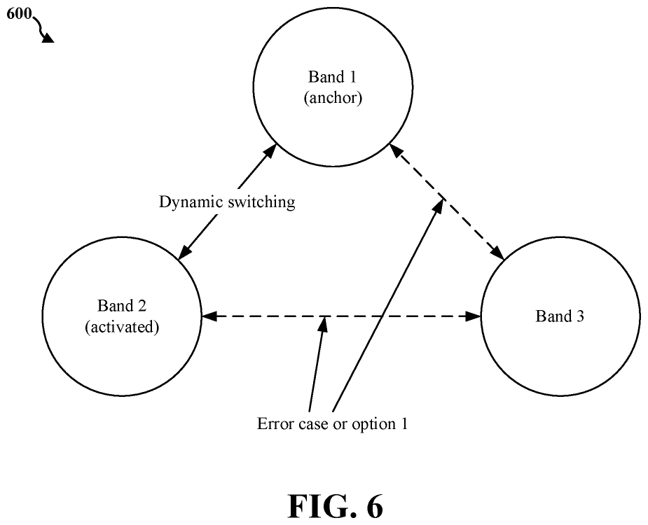

Further, in some alternative aspects, an anchor band is defined among all the bands, and the anchor band is always active. One or more other bands may then be activated by the network, as described, for example, with reference to FIG. 6 below.

Referring to FIG. 3, in one non-limiting example aspect, a UE may report the UL Tx switching capability 300 on two band pairs: “band 1+band 2” and “band 1+band 3” separately, but not on “band 2+band 3.” In this case, band 1 is a bridge band that is in both of the reported band pairs. Subsequently, if the UE is scheduled for UL Tx switching between band 1 and band 2, the UE switches directly between band 1 and 2. Similarly, if the UE is scheduled for UL Tx switching between band 1 and band 3, the UE switches directly between band 1 and 3. However, if the UE is scheduled for UL Tx switching between band 2 and band 3, the UE does not switch directly between band 2 and 3 because neither band 2 nor band 3 is a bridge band (which is band 1). In this case, one of band 2 or band 3 needs to first switch to the bridge band (band 1). For example, in order to switch from band 2 to band 3, the UE switches from band 2 to the bridge band (band 1), and then from the bridge band (band 1) to band 3, and the switching periods are accumulated.

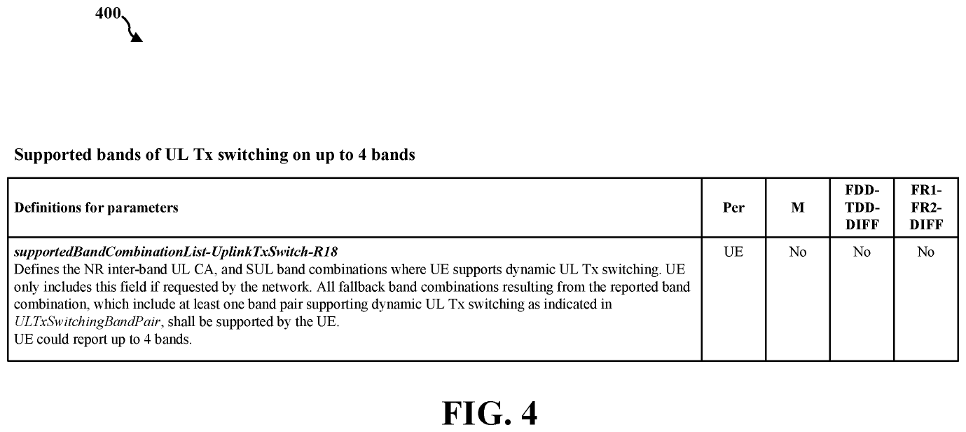

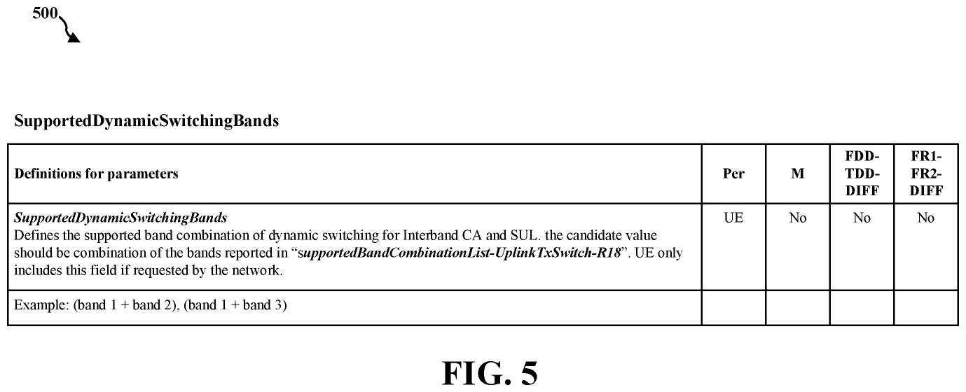

Referring to FIG. 4, in one non-limiting example aspect, the UE may transmit UE capability signaling, such as one or more parameters according to a UE capability report 400, indicating up to 4 supported bands for UL Tx switching. Also, referring to FIG. 5, in one non-limiting example aspect, the UE may report two or more band pairs for dynamic UL Tx switching, such as one or more parameters according to a UE capability report 500. The table column headers in FIGS. 4 and 5 are as defined by 3GPP TS 38.306. Specifically, in the tables of UE capability parameters in FIGS. 4 and 5, “Yes” in the column by “FDD-TDD DIFF” and “FR1-FR2 DIFF” indicates the UE capability field can have a different value for between FDD and TDD or between FR1 and FR2 and “No” indicates if it cannot. “FD” in the column indicates to refer the associated field description. “FR1 only” or “FR2 only” in the column indicates the associated feature is only supported in FR1 or FR2 and “TDD only” indicates the associated feature is only supported in TDD. “N/A” in the column indicates it is not applicable to the feature (e.g., the signaling supports the UE to have different values between FDD and TDD or between FR1 and FR2).

Referring to FIG. 6, in an alternative aspect, the UE may perform UL Tx switching 600 on an anchor band and another band, where the anchor band is always active, and the other band is configured/activated by the network for UL Tx switching. The activation of the other band may be via RRC or MAC-CE signaling. In FIG. 6, band 1 is the anchor band and is always active, and the network activates either band 2 or band 3 for dynamic switching. In one non-limiting aspect, the anchor band may be configured/activated by the network via RRC or MAC-CE signaling. In one non-limiting aspect, optionally, the UE may report the anchor band as a UE capability. In one non-limiting aspect, the anchor band may change if not reported by UE as a UE capability.

In FIG. 6, if the UE is scheduled for switching between band 1 and the activated/configured band 2, the UE directly switches between band 1 and band 2. In one non-limiting example aspect, the switching between band 1 and band 2 may be according to Option 1 (SwitchedUL with no simultaneous transmission as defined by 3GPP TS38.214) and/or Option 2 (DualUL with the possibility of simultaneous transmission as defined by 3GPP TS38.214), based on UE-reported switching option capability. For example, in one slot, the UE may have one layer of transmission at band 1 and one layer of transmission at band 2. In the next slot, the base station may schedule the UE for two layers of transmission at band 2 and no transmission at band 1. Accordingly, the UE switches the transmission chain from band 1 to band 2 in order to be able to support two layer transmission at band 2.

However, if the UE is scheduled for switching between band 3 (which is not activated) and another band, the UE may report an Error case, or may switch to band 3 according to Option 1 with no transmission from another band.

Some present aspects determine which band takes the switching period/gap in UL Tx switching. In Release 16, the ServingCellConfig information element includes the following:

| | |
|---|---|
| UplinkTxSwitching-r16 ::= | SEQUENCE { |
| uplinkTxSwitchingPeriodLocation-r16 | BOOLEAN, |
| uplinkTxSwitchingCarrier-r16 | ENUMERATED {carrier1, carrier2} |

In the above, the uplinkTxSwitchingPeriodLocation indicates whether the location of UL Tx switching period is configured in this uplink carrier in case of inter-band UL CA, SUL, or (NG)EN-DC, as specified in TS 38.101-1 and TS 38.101-3. In case of inter-band UL CA or SUL, the network configures this field to TRUE for one of the uplink carriers involved in dynamic UL TX switching and configures this field in the other carrier to FALSE. In case of (NG)EN-DC, the network always configures this field to TRUE for NR carrier (i.e., with (NG)EN-DC, the UL switching period always occurs on the NR carrier in order to not impact the LTE carrier).

However, in some present aspects, the network defines priorities for each one of multiple bands that can take the switching period/gap. If the switching is between two bands that are both configured with a gap, the switching gap is placed on the higher (or lower) priority band. In an aspect, for example, a field in the ServingCellConfig information element may be configured to indicate the priority of each band that can take the switching gap. In an aspect, the network guarantees that at least one of the bands in the switching is configured with a switching gap.

For example, in one non-limiting aspect, when UL Tx switching is configurable among bands 1, 2, and 3, the switching gap may be defined on band 1 and band 2. Thereafter, if the switching is between band 1 and band 2, the gap will be placed on the band with a higher (or lower) defined priority. However, if the switching is between band 3 and band 1, the switching gap is placed on band 1 because only band 1 can take the switching gap. Similarly, if the switching is between band 3 and band 2, the switching gap is placed on band 2 because only band 2 can take the switching gap.

In an alternative aspect, the network may configure the dynamic switching band pair, and also configure which band in the band pair takes the switching gap. For example, the network may configure dynamic switching between band 1 and band 2, and may also at the same time (e.g., in the same information element) configure the switching gap on either band 1 or band 2.

In an aspect, for example, the above two configurations are signaled in the same time scale, e.g., both are in RRC or both are in MAC-CE. For example, if the UL Tx switching band pair is configured in an RRC signaling, the switching gap is also configured in that RRC signaling. Similarly, if the UL Tx switching band pair is configured in a MAC-CE signaling, the switching gap is also configured in that MAC-CE signaling.

In an aspect, if the switching band pair is configured with MAC-CE signaling, the switching gap/period is not configured with RRC signaling. This is because if the switching band pair is changed with MAC-CE, configuring the switching gap with RRC takes a longer time because RRC is less frequent than MAC-CE, which may cause an error.

In one example implementation of one or more of the above aspects, the following UE capabilities are supported, however, others capabilities are not precluded. The UE reports that Option 2 (DualUL with the possibility of simultaneous transmission as defined by 3GPP TS38.214) is supported, which means the UE supports simultaneous transmission from two bands. Among 3 or 4 configured UL bands, one band is identified as the switching anchor band. If simultaneous transmission is supported between two bands, one of the two bands is always the switching anchor band. Among the other bands (other than the switching anchor band), each band may or may not support simultaneous transmission. In one optional aspect, for example, only the anchor band is capable of two transmissions, and the other bands are only capable of one transmission. For any RF state (transmit chain) switch, the anchor band is either the switch to, or the switch from, carrier/band. After one RF state switch, the next RF state switch occurs after 14 symbols or later, in order to avoid switching too frequently. For example, this will avoid switching at the end of one slot and switching again at the beginning of the next slot. Since the carriers in CA may have different subcarrier spacing (SCS), one aspect determines which SCS to use to calculate the 14 symbol duration above. An aspect also identifies on which carrier/band to place the switching gap. This may be based on how the dynamic switching is configured, as described herein with reference to various aspects.

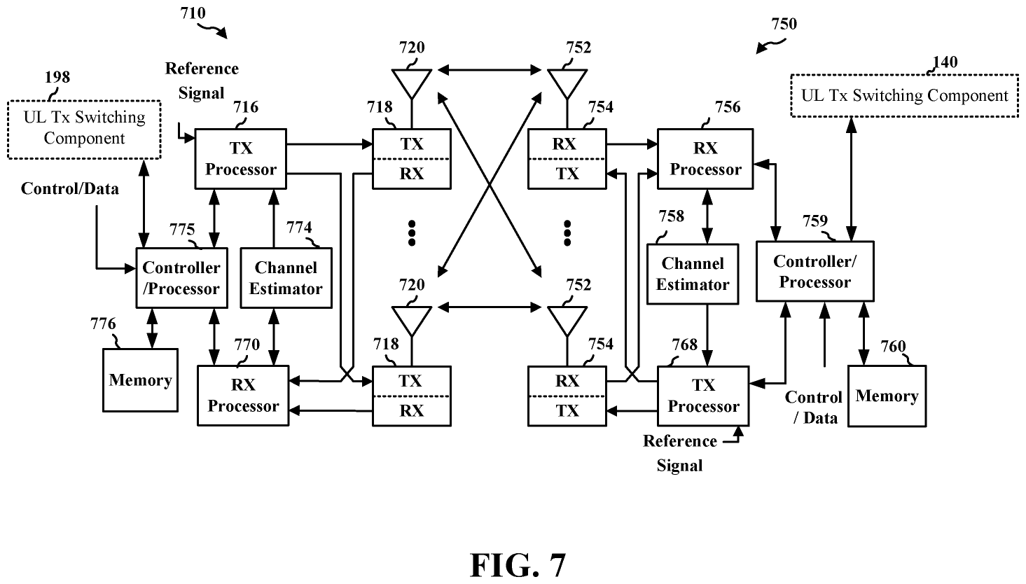

FIG. 7 is a block diagram of a base station 710 including an UL Tx switching component 198 in communication with a UE 750 including an UL Tx switching component 140 in an access network, where the base station 710 may be an example implementation of base station 102 and where UE 750 may be an example implementation of UE 104. In the DL, IP packets from the EPC 160 may be provided to a controller/processor 775. The controller/processor 775 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 775 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 716 and the receive (RX) processor 770 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 716 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream may then be provided to a different antenna 720 via a separate transmitter 718TX. Each transmitter 718TX may modulate an RF carrier with a respective spatial stream for transmission.

At the UE 750, each receiver 754RX receives a signal through its respective antenna 752. Each receiver 754RX recovers information modulated onto an RF carrier and provides the information to the receive (RX) processor 756. The TX processor 768 and the RX processor 756 implement layer 1 functionality associated with various signal processing functions. The RX processor 756 may perform spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 710. These soft decisions may be based on channel estimates computed by the channel estimator 758. The soft decisions are then decoded and deinterleaved to recover the data and control signals that were originally transmitted by the base station 710 on the physical channel. The data and control signals are then provided to the controller/processor 759, which implements layer 3 and layer 2 functionality.

The controller/processor 759 can be associated with a memory 760 that stores program codes and data. The memory 760 may be referred to as a computer-readable medium. In the UL, the controller/processor 759 provides demultiplexing between transport and logical channels, packet reassembly, deciphering, header decompression, and control signal processing to recover IP packets from the EPC 160. The controller/processor 759 is also responsible for error detection using an ACK and/or NACK protocol to support HARQ operations.

Similar to the functionality described in connection with the DL transmission by the base station 710, the controller/processor 759 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 758 from a reference signal or feedback transmitted by the base station 710 may be used by the TX processor 768 to select the appropriate coding and modulation schemes, and to facilitate spatial processing. The spatial streams generated by the TX processor 768 may be provided to different antenna 752 via separate transmitters 754TX. Each transmitter 754TX may modulate an RF carrier with a respective spatial stream for transmission.

The UL transmission is processed at the base station 710 in a manner similar to that described in connection with the receiver function at the UE 750. Each receiver 718RX receives a signal through its respective antenna 720. Each receiver 718RX recovers information modulated onto an RF carrier and provides the information to a RX processor 770.

The controller/processor 775 can be associated with a memory 776 that stores program codes and data. The memory 776 may be referred to as a computer-readable medium. In the UL, the controller/processor 775 provides demultiplexing between transport and logical channels, packet reassembly, deciphering, header decompression, control signal processing to recover IP packets from the UE 750. IP packets from the controller/processor 775 may be provided to the EPC 160. The controller/processor 775 is also responsible for error detection using an ACK and/or NACK protocol to support HARQ operations.

At least one of the TX processor 768, the RX processor 756, and the controller/processor 759 may be configured to perform aspects in connection with the UL Tx switching component 140 of FIG. 1.

At least one of the TX processor 716, the RX processor 770, and the controller/processor 775 may be configured to perform aspects in connection with the UL Tx switching component 198 of FIG. 1.

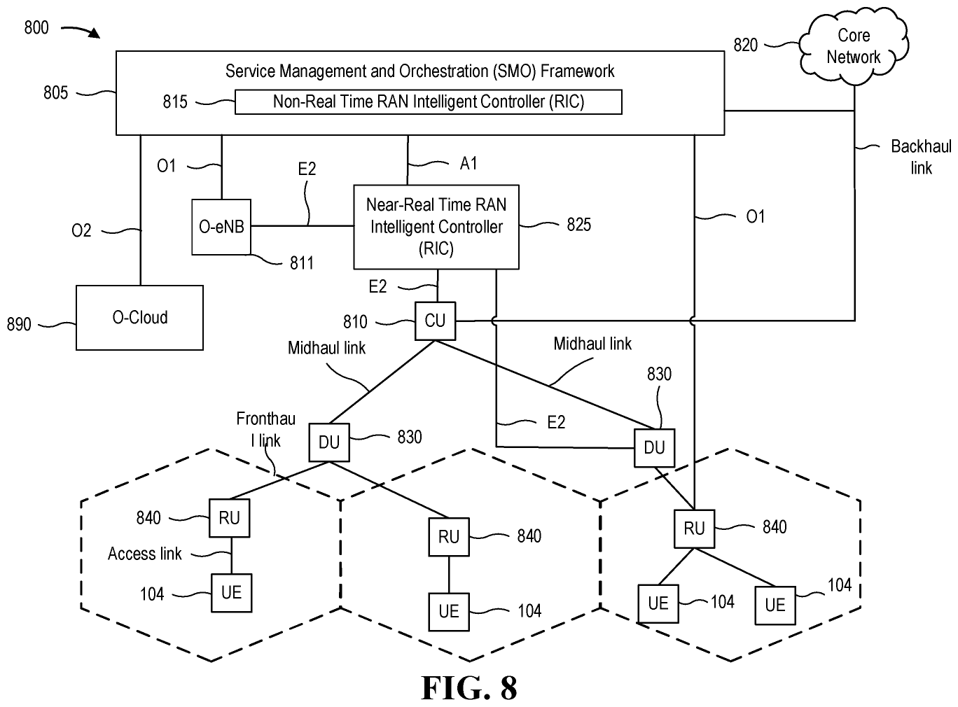

Referring to FIG. 8, an example of disaggregated base station 800 architecture, including one or more components that may act as a network device as described herein. The disaggregated base station 800 architecture may include one or more central units (CUs) 810 that can communicate directly with a core network 820 via a backhaul link, or indirectly with the core network 820 through one or more disaggregated base station units (such as a Near-Real Time (Near-RT) RAN Intelligent Controller (RIC) 825 via an E2 link, or a Non-Real Time (Non-RT) RIC 815 associated with a Service Management and Orchestration (SMO) Framework 805, or both). A CU 810 may communicate with one or more distributed units (DUs) 830 via respective midhaul links, such as an F1 interface. The DUs 830 may communicate with one or more radio units (RUs) 840 via respective fronthaul links. The RUs 840 may communicate with respective UEs 104 via one or more radio frequency (RF) access links. In some implementations, the UE 104 may be simultaneously served by multiple RUs 840.

Each of the units, e.g., the CUs 810, the DUs 830, the RUs 840, as well as the Near-RT RICs 825, the Non-RT RICs 815 and the SMO Framework 805, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 810 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 810. The CU 810 may be configured to handle user plane functionality (i.e., Central Unit—User Plane (CU-UP)), control plane functionality (i.e., Central Unit—Control Plane (CU-CP)), or a combination thereof. In some implementations, the CU 810 can be logically split into one or more CU-UP units and one or more CU-CP units. The CU-UP unit can communicate bidirectionally with the CU-CP unit via an interface, such as the E1 interface when implemented in an O-RAN configuration. The CU 810 can be implemented to communicate with the DU 830, as necessary, for network control and signaling.

The DU 830 may correspond to a logical unit that includes one or more base station functions to control the operation of one or more RUs 840. In some aspects, the DU 830 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 830 may further host one or more low PHY layers. Each layer (or module) can be implemented with an interface configured to communicate signals with other layers (and modules) hosted by the DU 830, or with the control functions hosted by the CU 810.

Lower-layer functionality can be implemented by one or more RUs 840. In some deployments, an RU 840, controlled by a DU 830, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 840 can be implemented to handle over the air (OTA) communication with one or more UEs 104. In some implementations, real-time and non-real-time aspects of control and user plane communication with the RU(s) 840 can be controlled by the corresponding DU 830. In some scenarios, this configuration can enable the DU(s) 830 and the CU 810 to be implemented in a cloud-based RAN architecture, such as a vRAN architecture.

The SMO Framework 805 may be configured to support RAN deployment and provisioning of non-virtualized and virtualized network elements. For non-virtualized network elements, the SMO Framework 805 may be configured to support the deployment of dedicated physical resources for RAN coverage requirements which may be managed via an operations and maintenance interface (such as an O1 interface). For virtualized network elements, the SMO Framework 805 may be configured to interact with a cloud computing platform (such as an open cloud (O-Cloud) 890) to perform network element life cycle management (such as to instantiate virtualized network elements) via a cloud computing platform interface (such as an 02 interface). Such virtualized network elements can include, but are not limited to, CUs 810, DUs 830, RUs 840 and Near-RT RICs 825. In some implementations, the SMO Framework 805 can communicate with a hardware aspect of a 4G RAN, such as an open eNB (O-eNB) 811, via an O1 interface. Additionally, in some implementations, the SMO Framework 805 can communicate directly with one or more RUs 840 via an O1 interface. The SMO Framework 805 also may include a Non-RT RIC 815 configured to support functionality of the SMO Framework 805.

The Non-RT RIC 815 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 825. The Non-RT RIC 815 may be coupled to or communicate with (such as via an A1 interface) the Near-RT RIC 825. The Near-RT RIC 825 may be configured to include a logical function that enables near-real-time control and optimization of RAN elements and resources via data collection and actions over an interface (such as via an E2 interface) connecting one or more CUs 810, one or more DUs 830, or both, as well as an O-eNB, with the Near-RT RIC 825.

In some implementations, to generate AI/ML models to be deployed in the Near-RT RIC 825, the Non-RT RIC 815 may receive parameters or external enrichment information from external servers. Such information may be utilized by the Near-RT RIC 825 and may be received at the SMO Framework 805 or the Non-RT RIC 815 from non-network data sources or from network functions. In some examples, the Non-RT RIC 815 or the Near-RT RIC 825 may be configured to tune RAN behavior or performance. For example, the Non-RT RIC 815 may monitor long-term trends and patterns for performance and employ AI/ML models to perform corrective actions through the SMO Framework 805 (such as reconfiguration via O1) or via creation of RAN management policies (such as A1 policies).

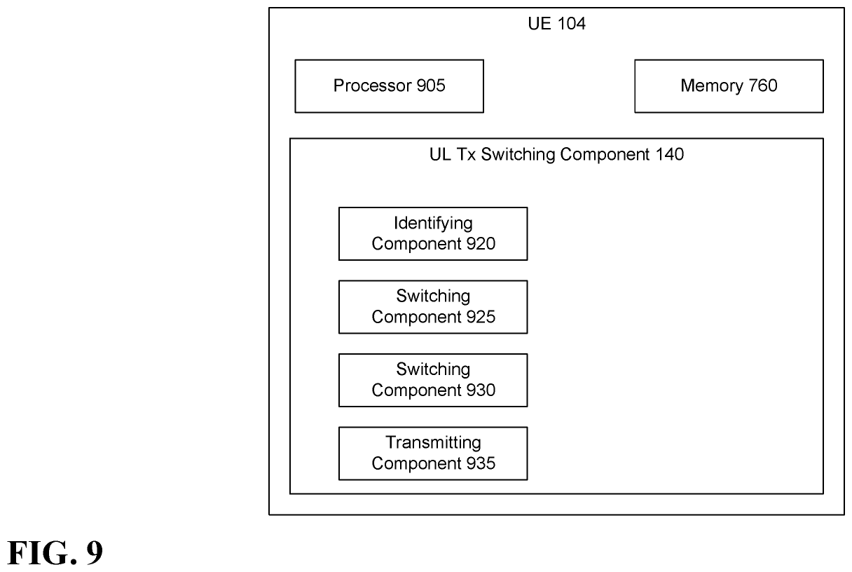

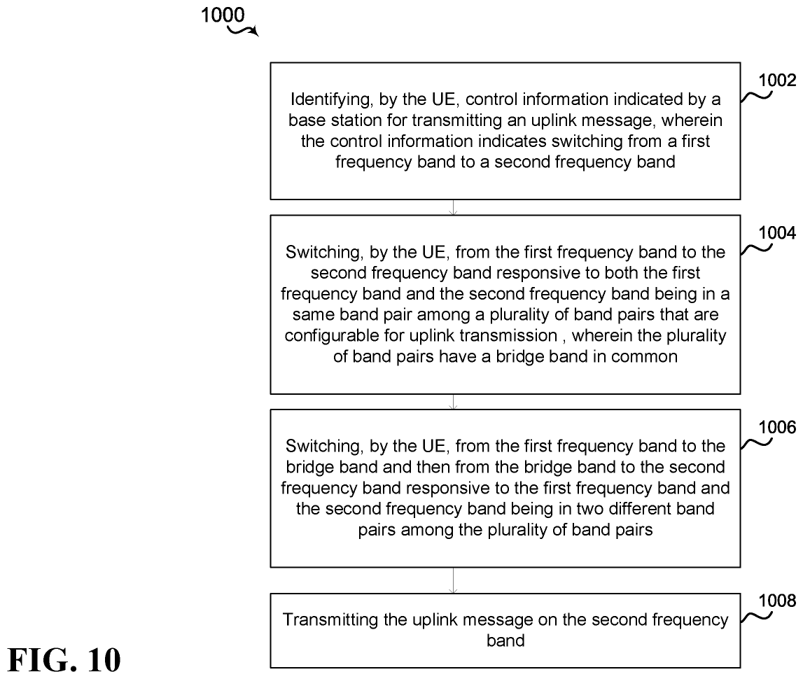

Referring to FIG. 9 and FIG. 10, in one implementation, UE 104 may perform a method 1000 of wireless communication, by such as via execution of UL Tx switching component 140 by processor 905 and/or memory 760. In this and other implementations described herein, processor 905 may include at least one of the TX processor 768, the RX processor 756, and the controller/processor 759 described above.

At block 1002, the method 1000 includes identifying, by the UE, control information indicated by a base station for transmitting an uplink message, wherein the control information indicates switching from a first frequency band to a second frequency band. For example, in an aspect, computer device 100, processor 905, memory 760, UL Tx switching component 140, and/or identifying component 920 may be configured to or may comprise means for identifying, by the UE, control information indicated by a base station for transmitting an uplink message, wherein the control information indicates switching from a first frequency band to a second frequency band.

For example, the identifying at block 1002 may be performed as described above.

At block 1004, the method 1000 includes switching, by the UE, from the first frequency band to the second frequency band responsive to both the first frequency band and the second frequency band being in a same band pair among a plurality of band pairs that are configurable for uplink transmission, wherein the plurality of band pairs have a bridge band in common. For example, in an aspect, computer device 100, processor 905, memory 760, UL Tx switching component 140, and/or switching component 925 may be configured to or may comprise means for switching, by the UE, from the first frequency band to the second frequency band responsive to both the first frequency band and the second frequency band being in a same band pair among a plurality of band pairs that are configurable for uplink transmission, wherein the plurality of band pairs have a bridge band in common.

For example, the switching at block 1004 may be performed as described above.

At block 1006, the method 1000 includes switching, by the UE, from the first frequency band to the bridge band and then from the bridge band to the second frequency band responsive to the first frequency band and the second frequency band being in two different band pairs among the plurality of band pairs. For example, in an aspect, computer device 100, processor 905, memory 760, UL Tx switching component 140, and/or switching component 930 may be configured to or may comprise means for switching, by the UE, from the first frequency band to the bridge band and then from the bridge band to the second frequency band responsive to the first frequency band and the second frequency band being in two different band pairs among the plurality of band pairs.

For example, the switching at block 1006 be performed as described above.

At block 1008, the method 1000 includes transmitting the uplink message on the second frequency band. For example, in an aspect, computer device 100, processor 905, memory 760, UL Tx switching component 140, and/or transmitting component 935 may be configured to or may comprise means for transmitting the uplink message on the second frequency band.

For example, the transmitting at block 1008 may be performed as described above. In an aspect, the UE is configured by the base station for uplink carrier aggregation (CA) on at least one of the first frequency band or the second frequency band.

In an aspect, the UE is configured by the base station for dual uplink transmission on at least one of the first frequency band or the second frequency band.

In an aspect, at least one of the first frequency band or the second frequency band is configured by the base station as a supplemental uplink (SUL) band.

In an aspect, the control information is included in DCI or RRC signaling.

In an aspect, the plurality of band pairs are indicated by the UE to the base station via a switching capability report.

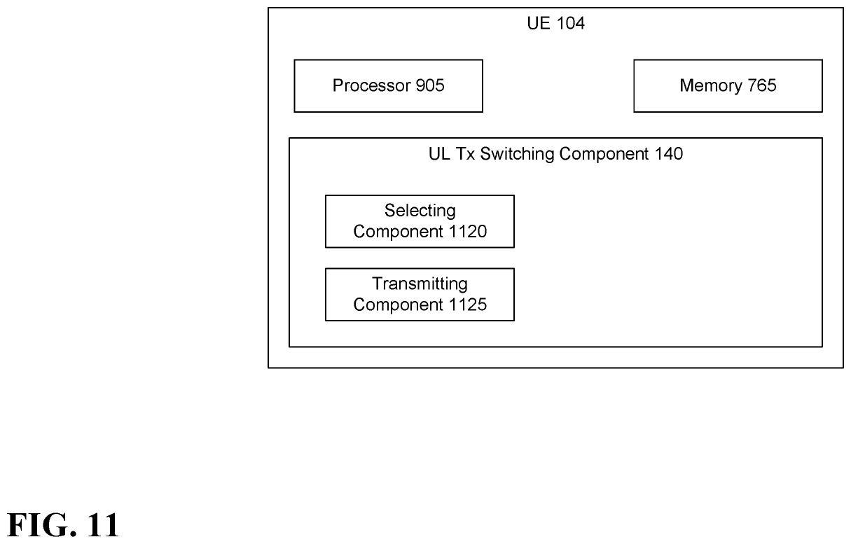

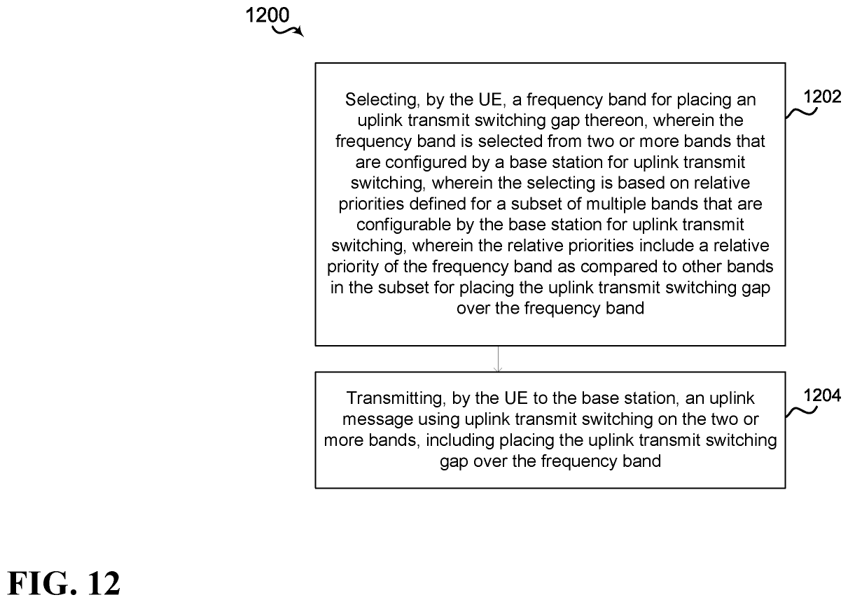

Referring to FIG. 11 and FIG. 12, in operation, UE 104 may perform a method 1200 of wireless communication, by such as via execution of UL Tx switching component 140 by processor 905 and/or memory 765.

At block 1202, the method 1200 includes selecting, by the UE, a frequency band for placing an uplink transmit switching gap thereon, wherein the frequency band is selected from two or more bands that are configured by a base station for uplink transmit switching, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band. For example, in an aspect, UE 104, processor 905, memory 765, UL Tx switching component 140, and/or selecting component 1120 may be configured to or may comprise means for selecting, by the UE, a frequency band for placing an uplink transmit switching gap thereon, wherein the frequency band is selected from two or more bands that are configured by a base station for uplink transmit switching, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band.

For example, the selecting at block 1202 may be performed as described above.

At block 1204, the method 1200 includes transmitting, by the UE to the base station, an uplink message using uplink transmit switching on the two or more bands, including placing the uplink transmit switching gap over the frequency band. For example, in an aspect, UE 104, processor 905, memory 765, UL Tx switching component 140, and/or transmitting component 1125 may be configured to or may comprise means for transmitting, by the UE to the base station, an uplink message using uplink transmit switching on the two or more bands, including placing the uplink transmit switching gap over the frequency band.

For example, the transmitting at block 1204 may be performed as described above.

In an aspect, within the two or more bands that are configured by the base station for uplink transmit switching, only the frequency band is included in the subset.

In an aspect, responsive to more than one band of the two or more bands being in the subset, the uplink transmit switching gap is placed over the frequency band which has a highest or lowest priority among the more than one band.

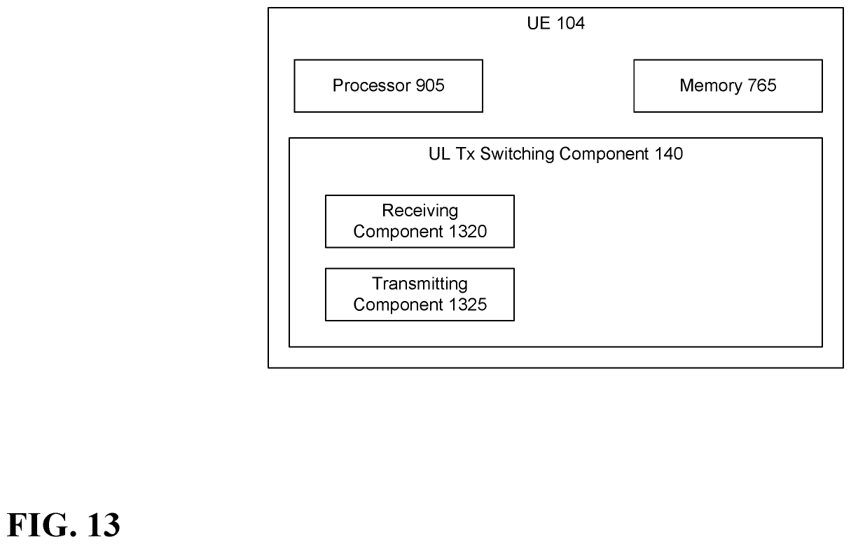

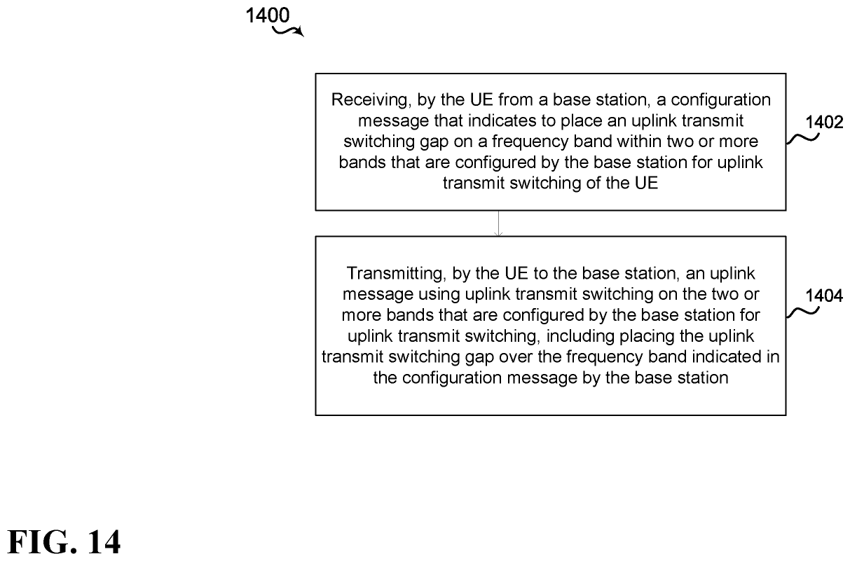

Referring to FIG. 13 and FIG. 14, in operation, UE 104 may perform a method 1400 of wireless communication, by such as via execution of UL Tx Switching Component 140 by processor 905 and/or memory 765.

At block 1402, the method 1400 includes receiving, by the UE from a base station, a configuration message that indicates to place an uplink transmit switching gap on a frequency band within two or more bands that are configured by the base station for uplink transmit switching of the UE. For example, in an aspect, UE 104, processor 905, memory 765, UL Tx Switching Component 140, and/or receiving component 1320 may be configured to or may comprise means for receiving, by the UE from a base station, a configuration message that indicates to place an uplink transmit switching gap on a frequency band within two or more bands that are configured by the base station for uplink transmit switching of the UE.

For example, the receiving at block 1402 may be performed as described above.

At block 1404, the method 1400 includes transmitting, by the UE to the base station, an uplink message using uplink transmit switching on the two or more bands that are configured by the base station for uplink transmit switching, including placing the uplink transmit switching gap over the frequency band indicated in the configuration message by the base station. For example, in an aspect, UE 104, processor 905, memory 765, UL Tx Switching Component 140, and/or transmitting component 1325 may be configured to or may comprise means for transmitting, by the UE to the base station, an uplink message using uplink transmit switching on the two or more bands that are configured by the base station for uplink transmit switching, including placing the uplink transmit switching gap over the frequency band indicated in the configuration message by the base station.

For example, the transmitting at block 1404 may be performed as described above.

In an aspect, configuring the two or more bands for uplink transmit switching and configuring the frequency band for placing the uplink transmit switching gap thereon are performed together in a same time scale.

In an aspect, configuring the two or more bands for uplink transmit switching and configuring the frequency band for placing the uplink transmit switching gap thereon are performed together in RRC signaling.

In an aspect, configuring the two or more bands for uplink transmit switching and configuring the frequency band for placing the uplink transmit switching gap thereon are performed together in MAC-CE signaling.

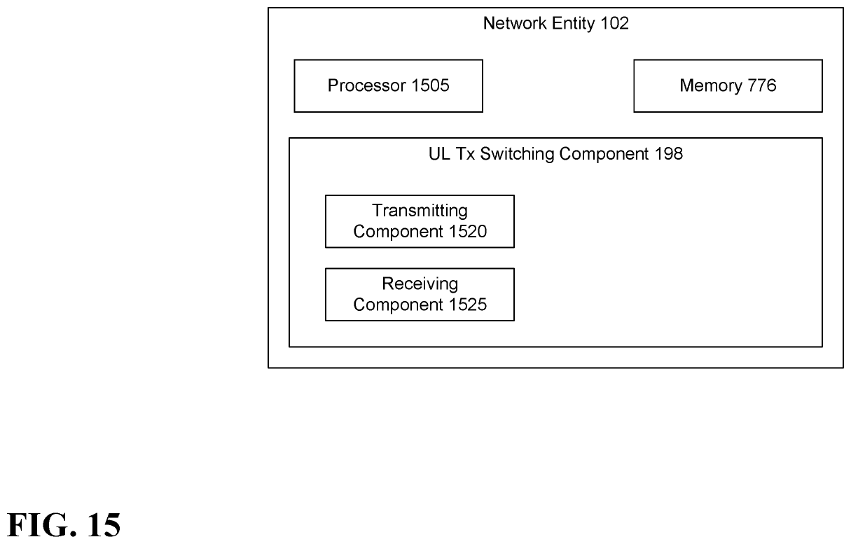

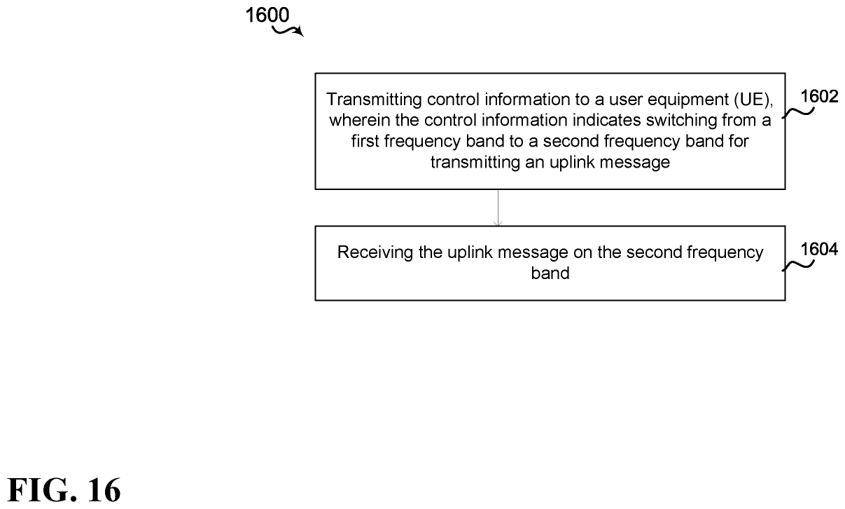

Referring to FIG. 15 and FIG. 16, in operation, network entity 102 may perform a method 1600 of wireless communication, by such as via execution of UL Tx switching component 198 by processor 1505 and/or memory 113. In this and other implementations described herein, processor 1505 may include at least one of the TX processor 716, the RX processor 770, and the controller/processor 775 described above.

At block 1602, the method 1600 includes transmitting control information to a user equipment (UE), wherein the control information indicates switching from a first frequency band to a second frequency band for transmitting an uplink message; wherein the control information causes the UE to switch from the first frequency band to the second frequency band responsive to both the first frequency band and the second frequency band being in a same band pair among a plurality of band pairs that are configurable for uplink transmission, wherein the plurality of band pairs have a bridge band in common; wherein the control information causes the UE to switch from the first frequency band to the bridge band and then from the bridge band to the second frequency band responsive to the first frequency band and the second frequency band being in two different band pairs among the plurality of band pairs. For example, in an aspect, network entity 102, processor 1505, memory 113, UL Tx switching component 198, and/or transmitting component 1520 may be configured to or may comprise means for transmitting control information to a user equipment (UE), wherein the control information indicates switching from a first frequency band to a second frequency band for transmitting an uplink message; wherein the control information causes the UE to switch from the first frequency band to the second frequency band responsive to both the first frequency band and the second frequency band being in a same band pair among a plurality of band pairs that are configurable for uplink transmission, wherein the plurality of band pairs have a bridge band in common; wherein the control information causes the UE to switch from the first frequency band to the bridge band and then from the bridge band to the second frequency band responsive to the first frequency band and the second frequency band being in two different band pairs among the plurality of band pairs.

For example, the transmitting at block 1602 may be performed as described above.

At block 1604, the method 1600 includes receiving the uplink message on the second frequency band. For example, in an aspect, network entity 102, processor 1505, memory 113, UL Tx switching component 198, and/or receiving component 1525 may be configured to or may comprise means for receiving the uplink message on the second frequency band.

For example, the receiving at block 1604 may be performed as described above.

In an aspect, the UE is configured by the base station for uplink carrier aggregation (CA) on at least one of the first frequency band or the second frequency band.

In an aspect, the UE is configured by the base station for dual uplink transmission on at least one of the first frequency band or the second frequency band.

In an aspect, at least one of the first frequency band or the second frequency band is configured by the base station as a supplemental uplink (SUL) band.

In an aspect, the control information is included in DCI or RRC signaling.

In an aspect, the plurality of band pairs are indicated by the UE to the base station via a switching capability report.

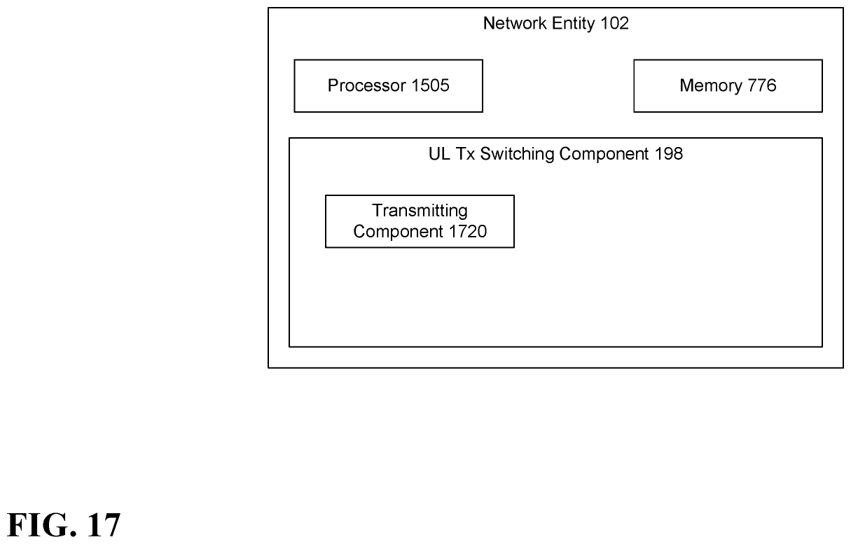

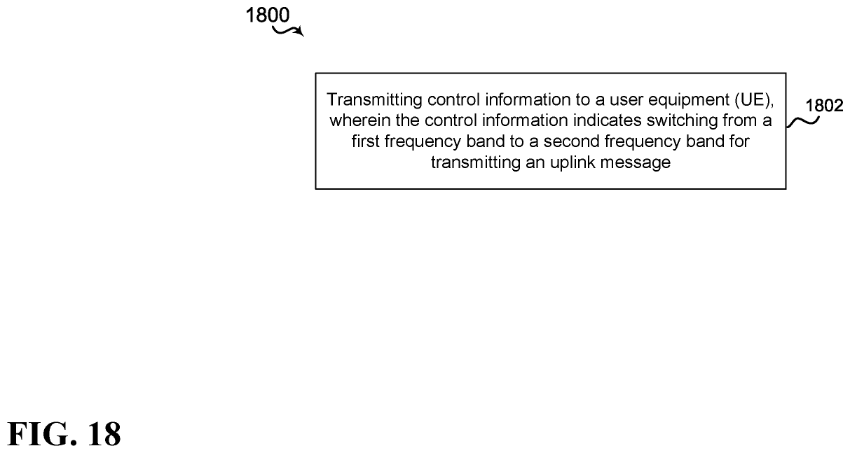

Referring to FIG. 17 and FIG. 18, in operation, network entity 102 may perform a method 1800 of wireless communication, by such as via execution of UL Tx switching component 198 by processor 1505 and/or memory 776.

At block 1802, the method 1800 includes transmitting control information to a user equipment (UE), wherein the control information indicates switching from a first frequency band to a second frequency band for transmitting an uplink message; wherein the control information causes the UE to switch from the first frequency band to the second frequency band responsive to one of the first frequency band and the second frequency band being an anchor band configured for the UE. For example, in an aspect, network entity 102, processor 1505, memory 776, UL Tx switching component 198, and/or transmitting component 1720 may be configured to or may comprise means for transmitting control information to a user equipment (UE), wherein the control information indicates switching from a first frequency band to a second frequency band for transmitting an uplink message; wherein the control information causes the UE to switch from the first frequency band to the second frequency band responsive to one of the first frequency band and the second frequency band being an anchor band configured for the UE.

For example, the transmitting at block 1802 may be performed as described above.

In an aspect, the anchor band is always activated.

In an aspect, a plurality of frequency bands other than the anchor band are always activated.

In an aspect, the method further comprises switching from the first frequency band to the second frequency band and ceasing simultaneous transmission on more than one band, responsive to neither one of the first frequency band or the second frequency band being the anchor band, wherein the second frequency band supports a single layer transmission.

In an aspect, the anchor band is configured by the base station via RRC signaling or activated by the base station via MAC-CE signaling.

In an aspect, at least one of the first frequency band or the second frequency band is configured by the base station via RRC signaling or activated by the base station via MAC-CE signaling.

In an aspect, the anchor band is indicated by the UE to the base station as a capability of the UE.

In an aspect, the anchor band is selected and configured by the base station responsive to the anchor band not being indicated by the UE as a capability of the UE.

In an aspect, the control information is included in a DCI, MAC-CE, or RRC signaling.

In an aspect, the switching is according to switched uplink with no simultaneous transmission or dual uplink with simultaneous transmission, as indicated by a UE-reported switching option capability.

In an aspect, a plurality of bands including at least one of the first frequency band or the second frequency band are indicated by the UE to the base station via a switching capability report.

In an aspect, an uplink transmit switching gap is placed on the anchor band.

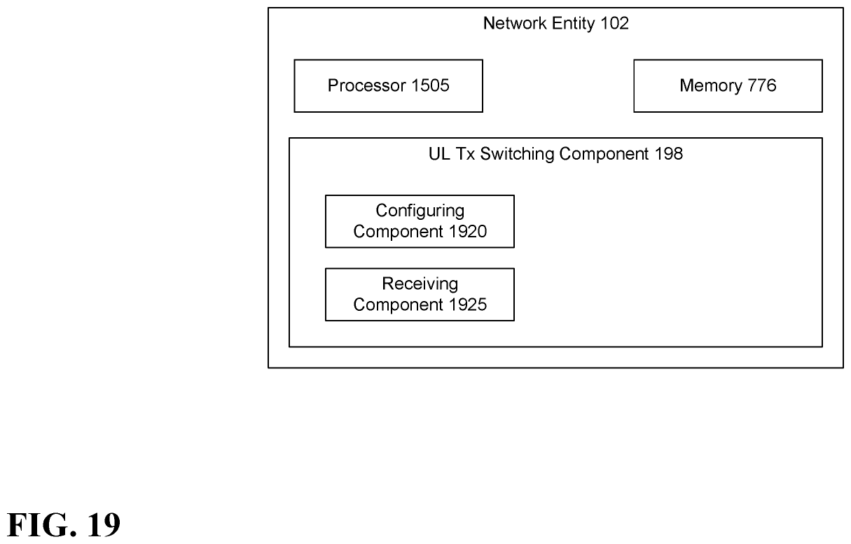

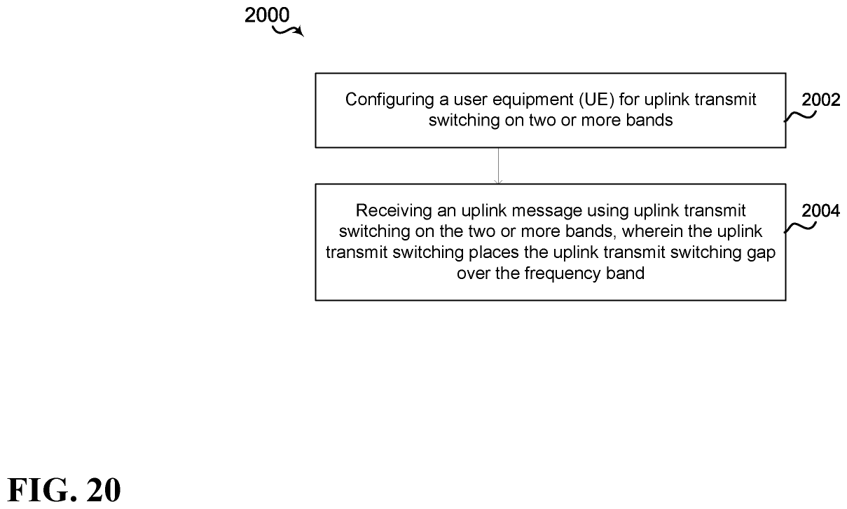

Referring to FIG. 19 and FIG. 20, in operation, network entity 102 may perform a method 2000 of wireless communication, by such as via execution of UL Tx switching component 198 by processor 1505 and/or memory 776.

At block 2002, the method 2000 includes configuring a user equipment (UE) for uplink transmit switching on two or more bands; wherein the configuring causes the UE to select a frequency band for placing an uplink transmit switching gap thereon, wherein the frequency band is selected from the two or more bands, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band. For example, in an aspect, network entity 102, processor 1505, memory 776, UL Tx switching component 198, and/or configuring component 1920 may be configured to or may comprise means for configuring a user equipment (UE) for uplink transmit switching on two or more bands; wherein the configuring causes the UE to select a frequency band for placing an uplink transmit switching gap thereon, wherein the frequency band is selected from the two or more bands, wherein the selecting is based on relative priorities defined for a subset of multiple bands that are configurable by the base station for uplink transmit switching, wherein the relative priorities include a relative priority of the frequency band as compared to other bands in the subset for placing the uplink transmit switching gap over the frequency band.

For example, the configuring at block 1802 may be performed as described above.

At block 2004, the method 2000 includes receiving an uplink message using uplink transmit switching on the two or more bands, wherein the uplink transmit switching places the uplink transmit switching gap over the frequency band. For example, in an aspect, network entity 102, processor 1505, memory 776, UL Tx switching component 198, and/or receiving component 1925 may be configured to or may comprise means for receiving an uplink message using uplink transmit switching on the two or more bands, wherein the uplink transmit switching places the uplink transmit switching gap over the frequency band.

For example, the receiving at block 2004 may be performed as described above.

In an aspect, within the two or more bands that are configured by the base station for uplink transmit switching, only the frequency band is included in the subset.

In an aspect, responsive to more than one band of the two or more bands being in the subset, the uplink transmit switching gap is placed over the frequency band which has a highest or lowest priority among the more than one band.

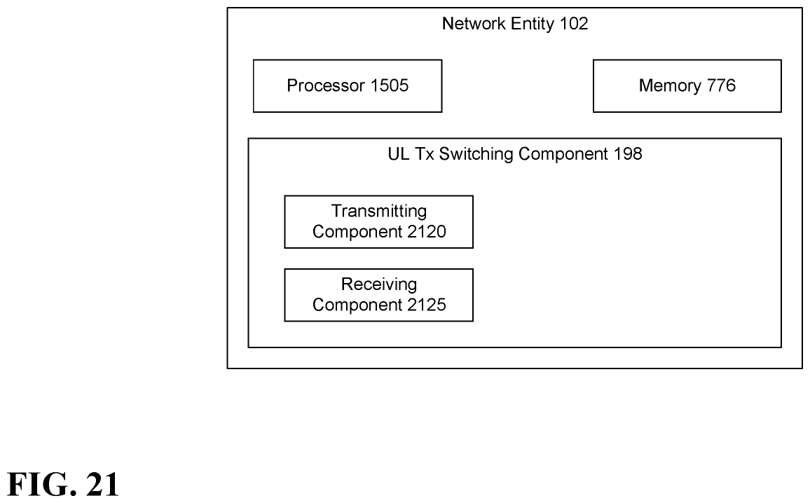

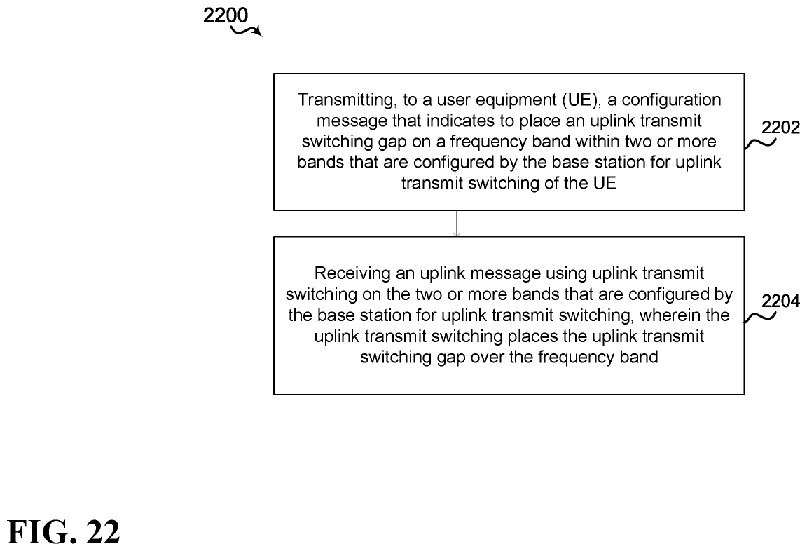

Referring to FIG. 21 and FIG. 22, in operation, network entity 102 may perform a method 2200 of wireless communication, by such as via execution of UL Tx Switching Component 198 by processor 1505 and/or memory 776.

At block 2202, the method 2200 includes transmitting, to a user equipment (UE), a configuration message that indicates to place an uplink transmit switching gap on a frequency band within two or more bands that are configured by the base station for uplink transmit switching of the UE. For example, in an aspect, network entity 102, processor 1505, memory 776, UL Tx Switching Component 198, and/or transmitting component 2120 may be configured to or may comprise means for transmitting, to a user equipment (UE), a configuration message that indicates to place an uplink transmit switching gap on a frequency band within two or more bands that are configured by the base station for uplink transmit switching of the UE.

For example, the transmitting at block 2202 may be performed as described above.

At block 2204, the method 2200 includes receiving an uplink message using uplink transmit switching on the two or more bands that are configured by the base station for uplink transmit switching, wherein the uplink transmit switching places the uplink transmit switching gap over the frequency band. For example, in an aspect, network entity 102, processor 1505, memory 776, UL Tx Switching Component 198, and/or receiving component 2125 may be configured to or may comprise means for receiving an uplink message using uplink transmit switching on the two or more bands that are configured by the base station for uplink transmit switching, wherein the uplink transmit switching places the uplink transmit switching gap over the frequency band.

For example, the receiving at block 2204 may be performed as described above.

In an aspect, configuring the two or more bands for uplink transmit switching and configuring the frequency band for placing the uplink transmit switching gap thereon are performed together in a same time scale.

In an aspect, configuring the two or more bands for uplink transmit switching and configuring the frequency band for placing the uplink transmit switching gap thereon are performed together in RRC signaling.

In an aspect, configuring the two or more bands for uplink transmit switching and configuring the frequency band for placing the uplink transmit switching gap thereon are performed together in MAC-CE signaling.

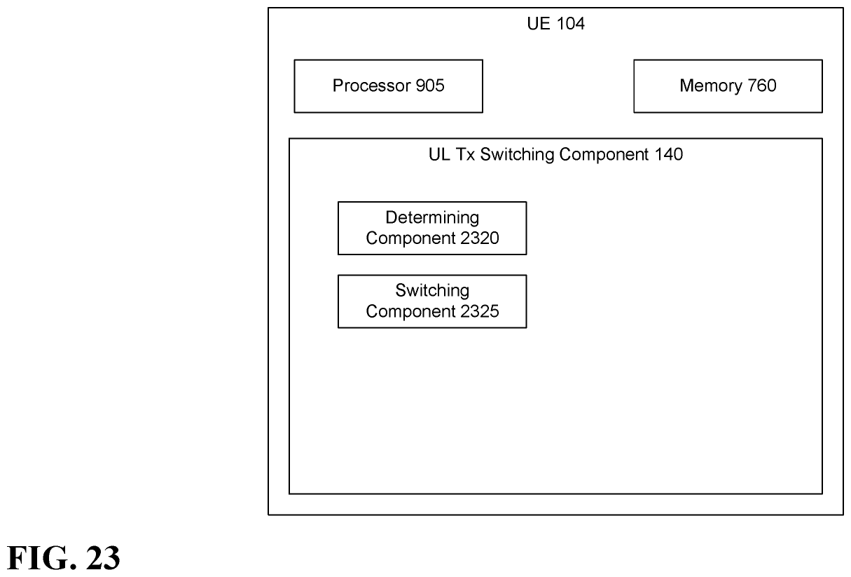

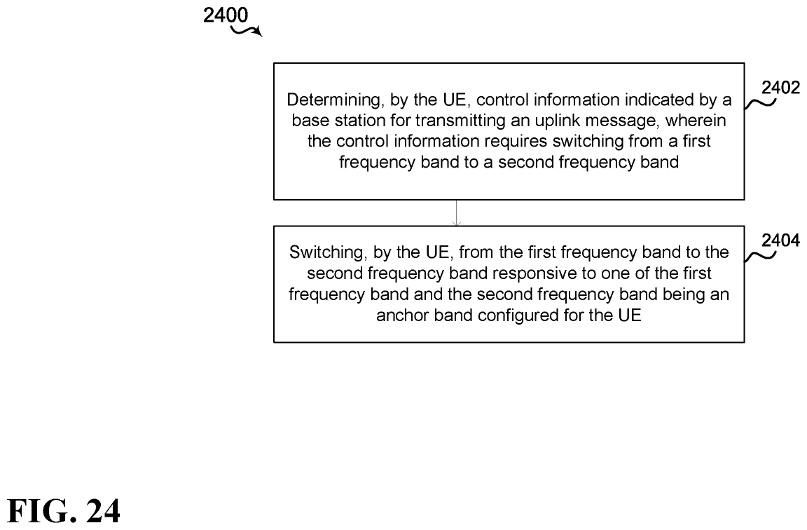

Referring to FIG. 23 and FIG. 24, in operation, UE 104 may perform a method 2400 of wireless communication, by such as via execution of UL Tx switching component 140 by processor 905 and/or memory 760.

At block 2402, the method 2400 includes determining, by the UE, control information indicated by a base station for transmitting an uplink message, wherein the control information requires switching from a first frequency band to a second frequency band. For example, in an aspect, UE 104, processor 905, memory 760, UL Tx switching component 140, and/or determining component 2320 may be configured to or may comprise means for determining, by the UE, control information indicated by a base station for transmitting an uplink message, wherein the control information requires switching from a first frequency band to a second frequency band.

For example, the determining at block 2402 may be performed as described above.

At block 2404, the method 2400 includes switching, by the UE, from the first frequency band to the second frequency band responsive to one of the first frequency band and the second frequency band being an anchor band configured for the UE. For example, in an aspect, UE 104, processor 905, memory 760, UL Tx switching component 140, and/or switching component 2325 may be configured to or may comprise means for switching, by the UE, from the first frequency band to the second frequency band responsive to one of the first frequency band and the second frequency band being an anchor band configured for the UE.

For example, the switching at block 2404 may be performed as described above.

In an aspect, the anchor band is always activated.

In an aspect, a plurality of frequency bands other than the anchor band are always activated.

In an aspect, the method further comprises switching from the first frequency band to the second frequency band and ceasing simultaneous transmission on more than one band, responsive to neither one of the first frequency band or the second frequency band being the anchor band, wherein the second frequency band supports a single layer transmission.

In an aspect, the anchor band is configured by the base station via RRC signaling or activated by the base station via MAC-CE signaling.

In an aspect, at least one of the first frequency band or the second frequency band is configured by the base station via RRC signaling or activated by the base station via MAC-CE signaling.

In an aspect, the anchor band is indicated by the UE to the base station as a capability of the UE.

In an aspect, the anchor band is selected and configured by the base station responsive to the anchor band not being indicated by the UE as a capability of the UE.

In an aspect, the control information is included in a DCI, MAC-CE, or RRC signaling.

In an aspect, the switching is according to switched uplink with no simultaneous transmission or dual uplink with simultaneous transmission, as indicated by a UE-reported switching option capability.

In an aspect, a plurality of bands including at least one of the first frequency band or the second frequency band are indicated by the UE to the base station via a switching capability report.

In an aspect, an uplink transmit switching gap is placed on the anchor band.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

1. A method of wireless communication by a user equipment (UE), comprising:
identifying, by the UE, control information indicated by a base station for transmitting an uplink message, wherein the control information indicates switching from a first frequency band to a second frequency band; and
switching, by the UE, from the first frequency band to the second frequency band responsive to one of the first frequency band and the second frequency band being an anchor band configured for the UE or responsive to both the first frequency band and the second frequency band being in a same band pair among a plurality of band pairs that are configurable for uplink transmission.

2. The method of claim 1, wherein the plurality of band pairs have a bridge band in common, the method further comprising:
switching, by the UE, from the first frequency band to the bridge band and then from the bridge band to the second frequency band responsive to the first frequency band and the second frequency band being in two different band pairs among the plurality of band pairs; and
transmitting the uplink message on the second frequency band.

3. The method of claim 2, wherein the UE is configured, by the base station, for uplink carrier aggregation (CA) and/or for dual uplink transmission, on at least one of the first frequency band or the second frequency band.

4. The method of claim 2, wherein at least one of the first frequency band or the second frequency band is configured by the base station as a supplemental uplink (SUL) band.

5. The method of claim 2, wherein the control information is included in DCI or RRC signaling.

6. The method of claim 2, wherein the plurality of band pairs are indicated by the UE to the base station via a switching capability report.

7. (canceled)

8. The method of claim 1, wherein the anchor band is always activated.

9. The method of claim 1, wherein a plurality of frequency bands other than the anchor band are always activated.

10. The method of claim 1, further comprising switching from the first frequency band to the second frequency band and ceasing simultaneous transmission on more than one band, responsive to neither one of the first frequency band or the second frequency band being the anchor band, wherein the second frequency band supports a single layer transmission.

11. The method of claim 1, wherein the anchor band is configured by the base station via RRC signaling or activated by the base station via MAC-CE signaling.

12. The method of claim 1, wherein at least one of the first frequency band or the second frequency band is configured by the base station via RRC signaling or activated by the base station via MAC-CE signaling.

13. The method of claim 1, wherein the anchor band is indicated by the UE to the base station as a capability of the UE.

14. The method of claim 1, wherein the anchor band is selected and configured by the base station responsive to the anchor band not being indicated by the UE as a capability of the UE.

15. The method of claim 1, wherein the control information is included in a DCI, MAC-CE, or RRC signaling.

16. The method of claim 1, wherein the switching is according to switched uplink with no simultaneous transmission or dual uplink with simultaneous transmission, as indicated by a UE-reported switching option capability.

17. The method of claim 1, wherein a plurality of bands including at least one of the first frequency band or the second frequency band are indicated by the UE to the base station via a switching capability report.

18. The method of claim 1, wherein an uplink transmit switching gap is placed on the anchor band.

19. A method of wireless communication by a user equipment (UE), comprising:
selecting, by the UE, a frequency band for placing an uplink transmit switching gap thereon, wherein the frequency band is selected from two or more bands that are configured by a base station for uplink transmit switching, wherein the selecting is based on a configuration message received from the base station; and
transmitting, by the UE to the base station, an uplink message using uplink transmit switching on the two or more bands, including placing the uplink transmit switching gap over the frequency band.

20. The method of claim 19, wherein the configuration message indicates relative priorities defined for a subset of multiple bands that are configurable by the base station for uplink transmit switching, wherein the relative priorities include a relative priority of the frequency band as compared to other bands in the subset for placing the uplink transmit switching gap over the frequency band, wherein, within the two or more bands that are configured by the base station for uplink transmit switching, only the frequency band is included in the subset.

21. The method of claim 19, wherein the configuration message indicates relative priorities defined for a subset of multiple bands that are configurable by the base station for uplink transmit switching, wherein the relative priorities include a relative priority of the frequency band as compared to other bands in the subset for placing the uplink transmit switching gap over the frequency band, wherein responsive to more than one band of the two or more bands being in the subset, the uplink transmit switching gap is placed over the frequency band which has a highest or lowest priority among the more than one band.

22. The method of claim 19,
wherein the configuration message indicates to place the uplink transmit switching gap on the frequency band.

23. The method of claim 22, wherein configuring the two or more bands for uplink transmit switching and configuring the frequency band for placing the uplink transmit switching gap thereon are performed together in a same time scale.

24. The method of claim 22, wherein configuring the two or more bands for uplink transmit switching and configuring the frequency band for placing the uplink transmit switching gap thereon are performed together in RRC signaling.

25. The method of claim 22, wherein configuring the two or more bands for uplink transmit switching and configuring the frequency band for placing the uplink transmit switching gap thereon are performed together in MAC-CE signaling.

26. A method of wireless communication by a base station, comprising:
transmitting control information to a user equipment (UE), wherein the control information indicates switching from a first frequency band to a second frequency band for transmitting an uplink message; and
wherein the control information causes the UE to switch from the first frequency band to the second frequency band responsive to one of the first frequency band and the second frequency band being an anchor band configured for the UE or responsive to both the first frequency band and the second frequency band being in a same band pair among a plurality of band pairs that are configurable for uplink transmission.

27. The method of claim 26, wherein the plurality of band pairs have a bridge band in common, wherein the control information causes the UE to switch from the first frequency band to the bridge band and then from the bridge band to the second frequency band responsive to the first frequency band and the second frequency band being in two different band pairs among the plurality of band pairs, the method further comprising:
receiving the uplink message on the second frequency band.

28-32. (canceled)

33. The method of claim 26, wherein the anchor band is always activated.

34-43. (canceled)

44. A method of wireless communication by a base station, comprising:
configuring a user equipment (UE) for uplink transmit switching on two or more bands, including transmitting a configuration message to the UE;
wherein the configuring causes the UE to select a frequency band for placing an uplink transmit switching gap thereon, wherein the frequency band is selected from the two or more bands, wherein the selecting is based on the configuration message; and
receiving an uplink message using uplink transmit switching on the two or more bands, wherein the uplink transmit switching places the uplink transmit switching gap over the frequency band.

45. The method of claim 44, wherein the configuration message indicates relative priorities defined for a subset of multiple bands that are configurable by the base station for uplink transmit switching, wherein the relative priorities include a relative priority of the frequency band as compared to other bands in the subset for placing the uplink transmit switching gap over the frequency band.

46. (canceled)

47. The method of claim 44,
wherein the configuration message indicates to place the uplink transmit switching gap on the frequency band.
